(19) United States
(12) Patent Application Publication
(10) Pub. No.: US 2010/0125002 A1
(43) Pub. Date: May 20, 2010

(54) RESIN COMPOSITIONS INCORPORATING MODIFIED POLYISOCYANATE AND METHOD FOR THEIR MANUFACTURE AND USE

(75) Inventors: Hyun J. Kim, Carlsbad, CA (US); Hong G. Jeon, Carlsbad, CA (US); Jae S. Lee, Los Angeles, CA (US)

Correspondence Address: KLARQUIST SPARKMAN, LLP, 121 S.W. SALMON STREET, PORTLAND, OR, 97204, US

(73) Assignee: Taylor Made Golf Company, Inc.

(21) Appl. No.: 12/566,963

(22) Filed: Sep. 25, 2009

Related U.S. Application Data
(60) Provisional application No. 61/114,883, filed on Nov. 14, 2008.

(51) Int. Cl. A63B 37/12; A63B 37/00; C08L 75/04; B29C 70/02

(52) U.S. Cl. 473/374; 473/376; 473/377; 473/378; 525/424; 264/241

(57) ABSTRACT

Resin compositions incorporate (a) a functionalized polymeric material comprising at least one hydroxyl functional group, at least one amine functional group or at least one hydroxyl functional group and at least one amine functional group, and (b) at least one modified polyisocyanate to form a urethane, a urea, or a urethane/urea. The modified polyisocyanate typically has at least three isocyanate functional groups, which may include one or more blocked isocyanates by linkage. The resin compositions exhibit the ease of processing of a thermoplastic resin, but show the superior mechanical properties and excellent shear durability like a thermoset polyurethane.

### CROSS-REFERENCE TO RELATED APPLICATION

This application claims the benefit of the earlier filing date of U.S. Provisional Application No. 61/114,883, which was filed on Nov. 14, 2008. The entire disclosure of the provisional application is considered to be part of the disclosure of the following application and is incorporated herein by reference.

### FIELD

The present invention concerns a crosslinked resin composition that incorporates at least one functionalized polymeric material and at least one modified polyisocyanate, where the resin can be processed by conventional molding techniques, such as extrusion, injection molding, compression molding, and two-roll milling, and a method for making sporting equipment, such as golf balls, using the composition.

### BACKGROUND

Modern golf balls can be classified as one-piece balls, or multi-piece balls, such as two-piece and three-piece balls. One-piece balls are molded from a homogeneous mass of material upon which is molded a dimple pattern. One-piece balls are inexpensive and very durable, but do not provide great distance because of relatively high spin and low velocity. Two-piece balls are made by molding a cover around a solid rubber core. These are the most popular balls used today. To further modify ball performance, especially the distance balls travel, and the feel transmitted to the golfer through the club, the basic two-piece ball construction has been further modified by introducing additional layers between the core and outer cover layer.

Balata was used as the primary golf ball cover material for many years. However, synthetic polymer chemistry revolutionized golf ball performance and ball manufacturing processes. For example, SURLYN®, an ionomeric resin made by E.I. DuPont de Nemours & Co., was introduced in the 1960s. Ionomers typically cost less than balata and have better cut or shear resistance. Ionomers are the primary polymer used for either or both of the cover stock and intermediate layers for most two-piece and some three-piece golf balls. The problem with ionomer-covered golf balls, however, is that they often lack the desired “click” and “feel”. “Click” is the sound made when the ball is hit by a golf club, while “feel” is the overall sensation imparted to the golfer when the ball is hit.

Unlike ionomer-covered golf balls, polyurethane- or polyurea-covered golf balls can be made to have the “click” and “feel” of balata and the cut or shear resistance of balls made using ionomers. Polyurethanes or polyureas are typically prepared by reacting a diisocyanate with a polyol (in the case of polyurethanes) or with a polyamine (in the case of a polyurea). Thermoplastic polyurethanes or polyureas may consist solely of this initial mixture or may be further combined with a chain extender to vary physical properties, such as hardness. Thermoset polyurethanes or polyureas typically are formed by reacting a diisocyanate and a polyol or polyamine, respectively, and an additional crosslinking agent to crosslink or cure the material to produce a thermoset.

Golf ball covers comprising a thermoplastic polyurethane typically exhibit poor shear-cut resistance. Thus, while thermoplastic polyurethane covers are less expensive to make due to their superior processability, they are disfavored because of inferior ball performance. In contrast, golf ball layers prepared from thermosets, such as thermoset polyurethanes or polyureas, typically exhibit excellent shear-cut resistance and are much more scuff- and cut-resistant than thermoplastic polyurethanes or polyureas. Accordingly, it would be beneficial to golf ball producers to be able to use injection molding to prepare thermoset polyurethane or polyurea covers. Unfortunately, thermoset materials generally are not well suited for injection molding. As the reactants for thermoset polyurethanes or polyureas are mixed, they begin to cure and become highly viscous, which interferes with the injection molding process. Thus, thermoset materials typically are formed into a ball layer using a casting process that does not involve injection molding. In a casting process, the thermoset material is added directly to the mold sections immediately after it is created. The material is allowed to partially cure to a gelatinous state that will support the core. Once cured to this state, the core is positioned in one of the mold sections, and the two mold sections are mated. The material then cures to completion, forming a layer around the core. Positioning the core at the proper time is crucial for forming a layer having uniform thickness. The equipment used for this positioning is costly, because the core must be centered in the material in its gelatinous state, and at least one of the mold sections, after having material positioned therein, must be turned over and positioned onto its corresponding mold section. As a result, casting processes often lead to air pockets and voids in the layer being formed, resulting in a high incidence of rejected golf balls.

As a result, it would be advantageous to develop compositions that can be used to make products having excellent physical properties, such as shear durability, tensile properties and flexure properties, and yet still provide suitable flowability to facilitate processing.

### SUMMARY

Compositions within the scope of the present invention first can be easily processed as a thermoplastic material, and then can be induced to crosslink, to provide products having excellent physical properties. Disclosed embodiments of the composition comprise (a) at least one functionalized polymeric material having a hydroxyl group or groups, an amine group or groups, and any and all combinations thereof, and (b) at least one modified polyisocyanate. Functional groups provided by the polymeric material react with the modified polyisocyanate to form urethane, urea or urethane/urea linkages. The modified polyisocyanate has at least three isocyanate functional groups, which may include a blocked isocyanate that is formed by a reaction between two or multiple isocyanates. In particular embodiments, the modified polyisocyanate is selected from:

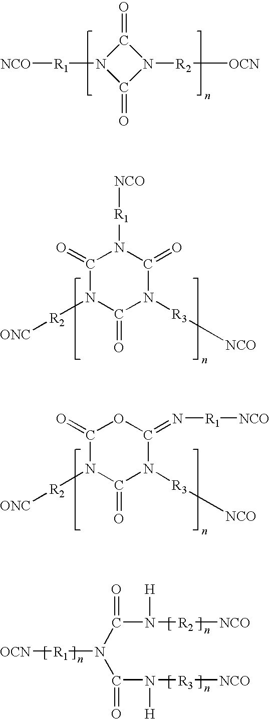

or mixtures thereof. With reference to these general formulas, n is 1 or greater. R₁, R₂, and R₃ independently are aliphatic, substituted aliphatic, cyclic aliphatic, aryl, or heteroaryl groups. More typically R₁, R₂ and R₃ independently are alkyl groups having from 1 to about 20 carbon atoms, phenyl groups, cyclic groups, or combinations thereof.

In other particular embodiments, the modified polyisocyanate includes isocyanates blocked by certain chemical groups. Any suitable blocking group can be used. Solely by way of example, and without limitation, suitable blocking groups include caprolactam, butanone oxime, 1,2-pyrazole, 1,2,4-triazole, diisopropylamine, 3,5-dimethylpyrazole, diethyl malonate, and combinations thereof.

One embodiment of a composition according to the present invention comprises a reaction product of a functionalized thermoplastic urethane, urea, urethane/urea having hydroxyl and/or amine functional groups with a modified polyisocyanate. The functionalized thermoplastic urethane, urea, or urethane/urea is obtained as a reaction product of any polyols and/or polyamine, chain extender, and any diisocyanates or isocyanate-terminated prepolymers. But the equivalent ratio (NCO/OH, NCO/NH₂ or NCO/OH+NH₂) between isocyanate functional groups of the diisocyanate and the hydroxyl and/or amino functional groups of the polyol and/or polyamine including chain extender is controlled to be less than 1.03. The functionalized thermoplastic urethane, urea, or urethane/urea can be an ester-type thermoplastic resin, an ether-type thermoplastic resin, or combinations thereof. Any suitable chain extender can be used. For example, the chain extender can be a polyol, such as a diol, a polyisocyanate, such as a diisocyanate, a polyamine, such as a diamine, or mixtures thereof.

Various different compounds can be formed by varying the relative amounts of the functionalized polymeric material or thermoplastic resin to the modified polyisocyanate or mixture of modified polyisocyanates. The modified polyisocyanate may be used in an amount of from about 0.1 to about 20 parts by weight, preferably from about 1 to about 10 parts by weight, per 100 parts by weight of the polymeric material or thermoplastic resin. The modified polyisocyanate can be a mixture of modified polyisocyanates, such as a mixture of a modified aromatic polyisocyanate and a modified aliphatic polyisocyanate, a mixture of different aliphatic polyisocyanates, a mixture of different aromatic polyisocyanates, and combinations thereof. For certain disclosed embodiments the mixture ratio between two different modified polyisocyanates comprises a weight ratio of from about 0.1:10 to about 10:0.1, more typically from about 1:5 to about 5:1. The modified polyisocyanate may have variable isocyanate content without limitation.

The composition can include any other desired compound, or mixture of compounds, suitable for making selected products. For example, the composition may include UV stabilizers, photostabilizers, antioxidants, colorants, dispersants, mold release agents, processing aids, fillers, nano-fillers, fibers, or mixtures thereof. Moreover, the composition may further comprise at least one additional polymeric material, such as an ionomeric polymer, non-ionomeric polymer, polyamide, silicone, styrenic-copolymers, or mixtures thereof.

Disclosed compositions have sufficient shear durability and excellent mechanical properties that make them suitable for making sports equipment, such as a recreation ball, a golf club or component thereof, such as a grip, shoes, glove, helmet, protective gears, bicycle, football, soccer, basketball, baseball, volley ball, hockey, ski, skate and the like. Disclosed golf balls comprise a core, and at least one additional layer made from disclosed resin compositions comprising the functionalized polymeric material, such as a functionalized thermoplastic resin and a modified polyisocyanate or mixture of modified polyisocyanates. Certain golf ball embodiments comprise at least one intermediate layer and a cover, at least one of the intermediate layer and cover comprising the crosslinked resin composition. For example, a three-piece golf ball typically has a rubber-based core, an intermediate layer and an outer cover layer, at least one of the intermediate layer and outer cover layer comprising the crosslinked resin composition. Similarly, a four-piece golf ball has a rubber-based core, an inner intermediate layer, an outer intermediate layer, and a cover, at least one of the inner layer, outer intermediate layer or cover comprising the crosslinked resin composition. The core can have at least one more layer. Such golf balls typically include a core having a diameter of about 0.5 inch or greater, a cover having a thickness of less than 0.1 inch, a Shore D hardness of from about 20 to about 80, and a cover with a difference in yellowness index of about 15 or less after about 2 days of ultraviolet light exposure.

A method for making sports equipment also is disclosed comprising providing, such as making or obtaining, disclosed crosslinked resin compositions, and making sports equipment using the composition. For golf balls, the method may comprise forming the crosslinked resin composition into half cups, and positioning the half cups about a core and an intermediate layer to form a layer. Forming the crosslinked resin composition into half cups can comprise injection molding, extrusion molding, two-roll milling, compression molding or casting.

### BRIEF DESCRIPTION OF THE DRAWINGS

FIG. 1 is a schematic cross section of a two-piece golf ball.

FIG. 2 is a schematic cross section of a three-piece golf ball.

FIG. 3 is a schematic cross section of a four-piece golf ball.

FIG. 4 is a schematic cross section of a five-piece golf ball.

### DETAILED DESCRIPTION

### I. Introduction and Definitions

The following definitions, presented in alphabetical order, are provided to aid the reader, and are not intended to provide term definitions that would be narrower than would be understood by a person of ordinary skill in the art of golf ball composition and manufacture.

Any numerical values recited herein include all values from the lower value to the upper value. All possible combinations of numerical values between the lowest value and the highest value enumerated herein are expressly included in this application.

The term “aliphatic” refers to a substantially hydrocarbon-based compound, or a radical thereof (e.g., C₆H₁₃, for a hexane radical), including alkanes, alkenes and alkynes, and further including straight- and branched-chain arrangements, and all stereo and position isomers as well.

The term “alkyl” typically is a univalent radical consisting of carbon and hydrogen atoms, arranged in a chain. Alkyl substituents form a homologous series with the general formula CₙH₂ₙ₊₁. Alkyl substituents include methyl, (CH₃—), ethyl (C₂H₅—), propyl (C₃H₇—), butyl (C₄H₉—), pentyl (C₅H₁₁—), and so on. The structure of an alkyl group is like that of its alkane counterpart, but with one less hydrogen atom.

The terms “aryl” and “heteroaryl” as used herein refer to any aryl group, which optionally can be substituted, or any “heteroaryl” group, which also optionally can be substituted, and include, by way of example and without limitation, phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl (4-furyl, 3-furyl), indolyl, oxadiazolyl, isoxazolyl, quinazolinyl, fluorenyl, xanthenyl, isoindanyl, benzhydryl, acridinyl, thiazolyl, pyrrolyl (2-pyrrolyl), pyrazolyl (3-pyrazolyl), imidazolyl (1-imidazolyl, 2-imidazolyl, 4-imidazolyl, 5-imidazolyl), triazolyl (1,2,3-triazol-1-yl, 1,2,3-triazol-2-yl 1,2,3-triazol-4-yl, 1,2,4-triazol-3-yl), oxazolyl (2-oxazolyl, 4-oxazolyl, 5-oxazolyl), thiazolyl (2-thiazolyl, 4-thiazolyl, 5-thiazolyl), pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl (2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl (2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl (2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl, 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-1-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl, 10,11-dihydro-5H-dibenz[b,f]azepine (10,11-dihydro-5H-dibenz[b,f]azepine-1-yl, 10,11-dihydro-5H-dibenz[b,f]azepine-2-yl.

The term “core” is intended to mean the elastic center of a golf ball, which may have a unitary construction. Alternatively the core itself may have a layered construction, e.g. having a spherical “center” and additional “core layers,” with such layers being made of the same material or a different material from the core center.

The term “cover” includes any layer of a golf ball that surrounds the core. Thus a golf ball cover may include both the outermost layer and also any intermediate layers, which are disposed between the golf ball center and outer cover layer. “Cover” may be used interchangeably with the term “cover layer”.

The term “cyclic” designates a substantially hydrocarbon, closed-ring compound, or a radical thereof. Cyclic compounds or substituents also can include one or more sites of unsaturation, but does not include aromatic compounds. One example of such a cyclic compound is cyclohexane.

A “fiber” is a general term and the definition provided by Engineered Materials Handbook, Vol. 2, “Engineering Plastics”, published by A.S.M. International, Metals Park, Ohio, USA, is relied upon to refer to filamentary materials with a finite length that is at least 100 times its diameter, which typically is 0.10 to 0.13 mm (0.004 to 0.005 in.). Fibers can be continuous or specific short lengths (discontinuous), normally no less than 3.2 mm (⅛ in.). Although fibers according to this definition are preferred, fiber segments, i.e., parts of fibers having lengths less than the aforementioned also are considered to be encompassed by the invention. Thus, the terms “fibers” and “fiber segments” are used herein. “Fibers or fiber segments” and “fiber elements” are used to encompass both fibers and fiber segments. Embodiments of the golf ball components described herein may include fibers including, by way of example and without limitation, glass fibers, such as E fibers, Cem-Fil filament fibers, and 204 filament strand fibers; carbon fibers, such as graphite fibers, high modulus carbon fibers, and high strength carbon fibers; asbestos fibers, such as chrysotile and crocidolite; cellulose fibers; aramid fibers, such as Kevlar, including types PRD 29 and PRD 49; and metallic fibers, such as copper, high tensile steel, and stainless steel. In addition, single crystal fibers, potassium titanate fibers, calcium sulphate fibers, and fibers or filaments of one or more linear synthetic polymers, such as Terylene, Dacron, Perlon, Orion, Nylon, including Nylon type 242, are contemplated. Polypropylene fibers, including monofilament and fibrillated fibers are also contemplated. Golf balls according to the present invention also can include any combination of such fibers. Fibers used in golf ball components are described more fully in Kim et al. U.S. Pat. No. 6,012,991, which is incorporated herein by reference.

In the case of a ball with two intermediate layers, the term “inner intermediate layer” may be used interchangeably herein with the terms “inner mantle” or “inner mantle layer” and is intended to mean the intermediate layer of the ball positioned nearest to the core.

The term “intermediate layer” may be used interchangeably with “mantle layer,” “inner cover layer” or “inner cover” and is intended to mean any layer(s) in a golf ball disposed between the core and the outer cover layer.

The term “(meth)acrylate” is intended to mean an ester of methacrylic acid and/or acrylic acid.

The term “(meth)acrylic acid copolymers” is intended to mean copolymers of methacrylic acid and/or acrylic acid.

A “nanocomposite” is defined as a polymer matrix having nanofiller within the matrix. Nanocomposite materials and golf balls made comprising nanocomposite materials are disclosed in Kim et al., U.S. Pat. No. 6,794,447, and U.S. Pat. Nos. 5,962,553 to Ellsworth, 5,385,776 to Maxfield et al., and 4,894,411 to Okada et al., which are incorporated herein by reference in their entirety.

The term “outer cover layer” is intended to mean the outermost cover layer of the golf ball on which, for example, the dimple pattern, paint and any writing, symbol, etc. is placed. If, in addition to the core, a golf ball comprises two or more cover layers, only the outermost layer is designated the outer cover layer. The remaining layers may be designated intermediate layers. The term outer cover layer is interchangeable with the term “outer cover”.

In the case of a ball with two intermediate layers, the term “outer intermediate layer” may be used interchangeably herein with the terms “outer mantle” or “outer mantle layer” and is intended to mean the intermediate layer of the ball which is disposed nearest to the outer cover layer.

“Peptizers” are chemical(s) or compositions that have been used by rubber compounders to facilitate the processing of natural or synthetic rubbers and other difficult-to-process, high viscosity elastomers during milling and mastication. Peptizers inhibit polymer cross-linking, most typically cross-linking of unsaturated polymers, but which can participate in polymer cross-linking after cross-linking is initiated.

The term “polyalkenamer” is used interchangeably herein with the term “polyalkenamer rubber” and means a polymer of one or more alkenes, including cycloalkenes, having from 5-20, preferably 5-15, most preferably 5-12 carbon atoms. The polyalkenamers may be prepared by any suitable method including ring opening metathesis polymerization of one or more cycloalkenes in the presence of organometallic catalysts as described in U.S. Pat. Nos. 3,492,245, and 3,804,803, the entire contents of both of which are incorporated herein by reference.

“Polymer precursor material” refers to any material that can be further processed to form a final polymer material of a manufactured golf ball, such as, by way of example and not limitation, monomers that can be polymerized, or a polymerized or partially polymerized material that can undergo additional processing, such as crosslinking.

The term “pseudo-crosslinked network” refers to materials that have crosslinking, but, unlike chemically vulcanized elastomers, pseudo-crosslinked networks are formed in-situ, not by covalent bonds, but instead by ionic clustering of the reacted functional groups, which clustering may disassociate at elevated temperatures.

The term “semi-interpenetrating network” refers to a network that includes at least one polymer component that is linear or branched and interspersed in the network structure of at least one of the other polymer components.

The term “substituted” refers to a fundamental compound, such as an aryl or aliphatic compound, or a radical thereof, having coupled thereto, typically in place of a hydrogen atom, a second substituent. For example, substituted aryl compounds or substituents may have an aliphatic group coupled to the closed ring of the aryl base, such as with toluene. Again solely by way of example and without limitation, a long-chain hydrocarbon may have a substituent bonded thereto, such as an aryl group, a cyclic group, a heteroaryl group or a heterocyclic group.

A “thermoplastic material” is generally defined as a material that is capable of softening or fusing when heated and of hardening again when cooled. Thermoplastic polymer chains often are not cross-linked, but the term “thermoplastic” as used herein may refer to materials that initially act as thermoplastics, such as during an initial extrusion process or injection molding process, but which also may be crosslinked, such as during a compression molding step to form a final structure.

A “thermoset material” is a material that solidifies or sets irreversibly, typically after heating or other processing.

### II. Golf Ball Construction

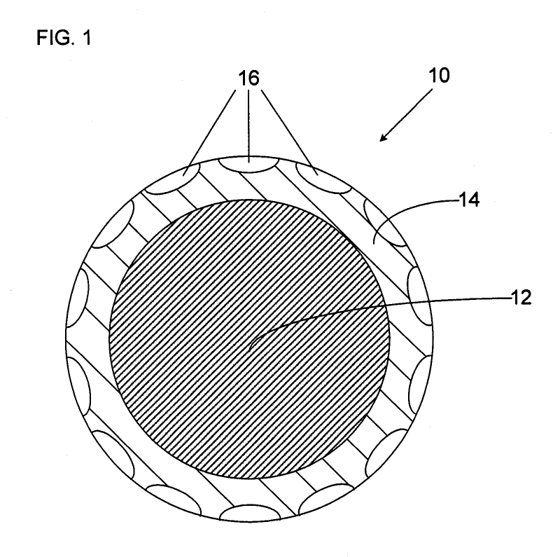

FIG. 1 illustrates a two-piece golf ball 10 comprising a solid center or core 12, and an outer cover layer 14. Golf balls also typically include plural dimples 16 formed in the outer cover and arranged in various desired patterns.

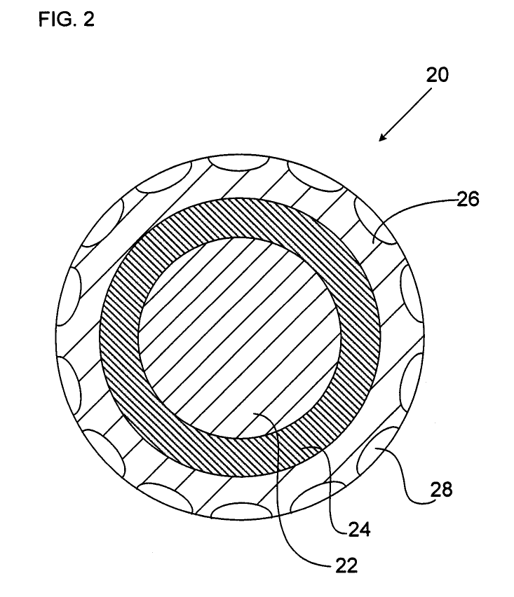

FIG. 2 illustrates a 3-piece golf ball 20 comprising a core 22, an intermediate layer 24 and an outer cover layer 26. Golf ball 20 also typically includes plural dimples 28 formed in the outer cover layer 26 and arranged in various desired patterns.

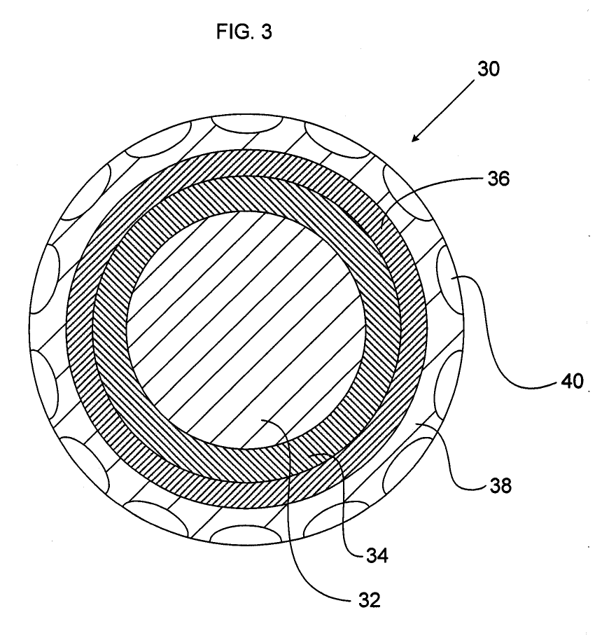

FIG. 3 illustrates a 4-piece golf ball 30 comprising a core 32, an inner intermediate layer 34, an outer intermediate layer 36 and an outer cover layer 38. Golf ball 30 also typically includes plural dimples 40 formed in the outer cover layer 38 and arranged in various desired patterns.

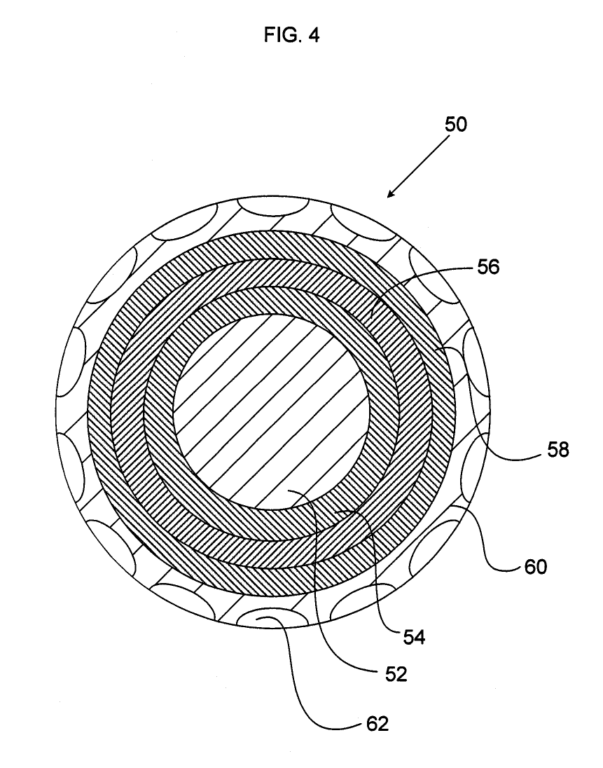

FIG. 4 illustrates a 5-piece golf ball 50 comprising a core 52, a first inner intermediate layer 54, a second inner intermediate layer 56, a third inner intermediate layer 58, and an outer cover layer 60. Golf ball 50 also typically includes plural dimples 62 formed in the outer cover layer 60 and arranged in various desired patterns.

FIGS. 1-4 illustrate two- to five-piece golf ball constructions. However, a person of ordinary skill in the art will appreciate that golf balls of the present invention may comprise any number of layers, including from 0 to at least 5 intermediate layer(s), but preferably from 0 to 3 intermediate layer(s), more preferably from 1 to 3 intermediate layer(s), and most preferably 1 to 2 intermediate layer(s).

The present invention can be used to form golf balls of any desired size. “The Rules of Golf” by the USGA dictate that the size of a competition golf ball must be at least 1.680 inches in diameter; however, golf balls of any size can be used for leisure golf play. The preferred diameter of the golf balls is from about 1.670 inches to about 1.800 inches. Oversize golf balls with diameters above about 1.760 inches to as big as 2.75 inches also are within the scope of the invention.

### A. Core

Ball cores of the present invention have a diameter of from about 0.1 to about 1.65 inches, preferably from about 0.3 to about 1.64 inches, more preferably from about 0.4 to about 1.62 inches, most preferably from about 0.5 to about 1.60 inches.

In another preferred embodiment, the golf ball core has at least one core layer on the center core, the layer having a thickness of from about 0.01 inch to about 1.14 inches, preferably from about 0.02 inch to about 1.12 inches, more preferably from about 0.025 inch to about 1.00 inches and most preferably from about 0.03 inch to about 0.08 inch.

In still another embodiment, two-piece balls are disclosed comprising a core and a cover having a thickness of from about 0.01 to about 0.20 inch, preferably from about 0.02 to about 0.15 inch, more preferably from about 0.025 to about 0.10 inch and most preferably from about 0.03 to about 0.08 inch. The cover typically has a hardness greater than about 25, preferably greater than about 30, and more preferably greater than about 40 Shore D. The ball typically has a PGA ball compression greater than about 30, preferably greater than 40, more preferably greater than about 50, most preferably greater than about 60.

The golf ball cores of the present invention typically have a PGA compression less than 140, preferably less than 120, more preferably less than 100, yet more preferably less than 90, and most preferably less than 80.

The Shore D hardness of the core center and core layers made according to the present invention may vary from about 10 to about 90, typically from about 20 to about 80, and even more typically from about 30 to about 70.

In yet other more detailed features of the invention at least one core or core layer includes an ionomeric polymer that comprises:
(a) an ionomeric polymer comprising one or more E/X/Y copolymers, wherein E is ethylene, X is a C₃ to C₈ α,β ethylenically unsaturated carboxylic acid, and Y is a softening comonomer selected from the group consisting of alkyl acrylate and alkyl methacrylate, wherein the alkyl groups have from 1 to 8 carbon atoms, or ionomers of such E/X/Y copolymers, wherein X is in the range of about 5 to about 35 weight % of the E/X/Y copolymer and Y is in the range of 0 to about 50 weight % of the E/X/Y copolymer, and wherein the acid groups present in said ionomeric polymer are partially neutralized with a metal selected from the group consisting of zinc, sodium, lithium, calcium, magnesium, and combinations thereof; or
(b) a bimodal ionomeric polymer comprising:
   (i) a high molecular weight component having a molecular weight in the range of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said high molecular weight component is partially neutralized with metal ions selected from the group consisting of lithium, sodium, zinc, calcium, magnesium, and combinations thereof, and
   (ii) a low molecular weight component having a molecular weight in the range of about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said low molecular weight component is partially neutralized with metal ions selected from the group consisting of lithium, sodium, zinc, calcium, magnesium, and combinations thereof; or
(c) a modified ionomeric polymer comprising:
   (i) a blend composition comprising:
      ethylene,
      5 to 25 weight percent (meth)acrylic acid (based on the total weight of said modified ionomeric polymer), and
      0 to 40 weight percent of a C₁ to C₈-alkyl acrylate (based on the total weight of said modified ionomeric polymer), and
      about 5 to about 45 weight percent (based on the total weight of said modified ionomeric polymer) of a fatty acid or one or more metal salts of a fatty acid, or
   (ii) a bimodal polymer blend composition comprising:
      a high molecular weight component having a molecular weight in the range of about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said high molecular weight component is partially neutralized with metal ions selected from the group consisting of lithium, sodium, zinc, calcium, magnesium, and combinations thereof,
      a low molecular weight component having a molecular weight in the range of about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said low molecular weight component is partially neutralized with metal ions selected from the group consisting of lithium, sodium, zinc, calcium, magnesium, and combinations thereof, and
      about 5 to about 45 weight percent (based on the total weight of said modified ionomeric polymer) of a fatty acid or one or more metal salts of a fatty acid; or
(d) a blend composition comprising the reaction product of:
   (i) one or more ionomers, and
   (ii) a compound having a general formula (R₂N)ₘ—R′—(X(O)ₙOR_{y})ₘ, where R is selected from hydrogen, one or more C₁-C₂₀ aliphatic systems, one or more cycloaliphatic systems, one or more aromatic systems, and combinations thereof; R′ is a bridging group comprising one or more unsubstituted C₁-C₂₀ straight chain or branched aliphatic or alicyclic groups, or one or more substituted straight chain or branched aliphatic or alicyclic groups, or one or more aromatic groups, or one or more oligomers each containing up to 12 repeating units, and where if X=C or S or P, m is 1-3; if X=C, n=1 and y=1; if X=S, n=2 and y=1; and if X=P, n=2 and y=2; or
(e) combinations of (a), (b), (c), and (d).

In yet other more detailed features of this invention, the composition of at least one outer core and core layer comprises polymer selected from the group consisting of thermoplastic resins, thermoset resins, thermoplastic polyurethane, thermoset polyurethane, polyamide elastomer, thermoplastic copolyetherester block copolymer, thermoplastic copolyesterester block copolymer, polyethylene-octene, polybutylene-octene, polyoctenamer, polyisoprene, 1,2-syndiotactic polybutadiene, thermoplastic vulcanizate, copolymeric ionomer, terpolymeric ionomer, polyurethane ionomer, polyamide ionomer, polycarbonate, polyolefin, polyamide, copolymeric polyamide, polyester, polyvinyl alcohol, acrylonitrile-butadiene-styrene copolymer, polyarylate, polyacrylate, polyphenylene ether, impact-modified polyphenylene ether, high impact polystyrene, diallyl phthalate polymer, metallocene catalyzed polymer, styrene-acrylonitrile (SAN) (including olefin-modified SAN and acrylonitrile-styrene-acrylonitrile), styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, polysiloxane, and combinations thereof. In yet other more detailed features of the invention, the core or the core layer can include polymer composition comprising (1) at least one unsaturated polymer, (2) at least one cross-linking agent, (3) at least one co-cross-linking agent, (4) optionally at least one peptizer, (5) optionally at least one accelerator, and (6) optionally at least one filler. The unsaturated polymer is selected from polyoctenamer, 1,2-polybutadiene, cis-1,4-polybutadiene, trans-1,4-polybutadiene, cis-polyisoprene, trans-polyisoprene, polychloroprene, polybutylene, styrene-butadiene rubber, styrene-butadiene-styrene block copolymer and partially hydrogenated equivalents, styrene-isoprene-styrene block copolymer and partially and hydrogenated equivalents, nitrile rubber, silicone rubber, and polyurethane, and combinations thereof. Polybutadiene rubbers, especially 1,4-polybutadiene rubbers containing at least 40 mol %, and more preferably 80 to 100 mol % of cis-1,4 bonds, are preferred because of their high rebound resilience, moldability, and high strength after vulcanization. The polybutadiene component may be synthesized by using rare earth-based catalysts, nickel-based catalysts, or cobalt-based catalysts, conventionally used in this field. Polybutadiene obtained by using lanthanum rare earth-based catalysts usually employ a combination of a lanthanum rare earth (atomic number of 57 to 71) compound, but particularly preferred is a neodymium compound.

The 1,4-polybutadiene rubbers have a molecular weight distribution (Mw/Mn) of from about 1.2 to about 4.0, preferably from about 1.7 to about 3.7, even more preferably from about 2.0 to about 3.5, most preferably from about 2.2 to about 3.2. The polybutadiene rubbers have a Mooney viscosity (ML₁₊₄(100° C.)) of from about 20 to about 80, preferably from about 30 to about 70, even more preferably from about 30 to about 60, most preferably from about 35 to about 50. The term “Mooney viscosity” as used herein refers in each case to an industrial index of viscosity as measured with a Mooney viscometer, which is a type of rotary plastometer (see JIS K6300). This value is represented by the symbol ML₁₊₄ (100° C.), wherein “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C.

Examples of suitable polyalkenamer rubbers are polypentenamer rubber, polyheptenamer rubber, polyoctenamer rubber, polydecenamer rubber and polydodecenamer rubber. For further details concerning polyalkenamer rubber, see Rubber Chem. & Tech., Vol. 47, page 511-596, 1974, which is incorporated herein by reference. Polyoctenamer rubbers are commercially available from Huls AG of Marl, Germany, and through its distributor in the U.S., Creanova Inc. of Somerset, N.J., and sold under the trademark VESTENAMER®. Two grades of the VESTENAMER® trans-polyoctenamer are commercially available: VESTENAMER 8012 designates a material having a trans-content of approximately 80% (and a cis-content of 20%) with a melting point of approximately 54° C.; and VESTENAMER 6213 designates a material having a trans-content of approximately 60% (cis-content of 40%) with a melting point of approximately 30° C. Both of these polymers have a double bond at every eighth carbon atom in the ring.

Preferable cross-linking agents include peroxides, sulfur compounds, and mixtures thereof. Non-limiting examples of suitable cross-linking agents include primary, secondary, or tertiary aliphatic or aromatic organic peroxides. Peroxides containing more than one peroxy group can be used, such as 2,5-dimethyl-2,5-di(tert-butylperoxy)hexane and 1,4-di-(2-tert-butyl peroxyisopropyl)benzene. Both symmetrical and asymmetrical peroxides can be used, for example, tert-butyl perbenzoate and tert-butyl cumyl peroxide. Peroxides incorporating carboxyl groups also are suitable. The decomposition of peroxides used as cross-linking agents in the disclosed compositions can be brought about by applying thermal energy, shear, irradiation, reaction with other chemicals, or any combination of these. Both homolytically and heterolytically decomposed peroxide can be used. Non-limiting examples of suitable peroxides include: diacetyl peroxide; di-tert-butyl peroxide; dibenzoyl peroxide; dicumyl peroxide; 2,5-dimethyl-2,5-di(benzoylperoxy)hexane; 1,4-bis-(t-butylperoxyisopropyl)benzene; t-butylperoxybenzoate; 2,5-dimethyl-2,5-di-(t-butylperoxy)hexyne-3, such as Trigonox 145-45B, marketed by AkzoNobel, with corporate headquarters in Amsterdam; 1,1-bis(t-butylperoxy)-3,3,5 tri-methylcyclohexane, such as Varox 231-XL, marketed by R.T. Vanderbilt Co., Inc. of Norwalk, Conn.; and di-(2,4-dichlorobenzoyl)peroxide. Each peroxide cross-linking agent has a characteristic decomposition temperature at which 50% of the cross-linking agent has decomposed when subjected to that temperature for a specified time period (t_{1/2}). For example, 1,1-bis-(t-butylperoxy)-3,3,5-tri-methylcyclohexane at t_{1/2}=0.1 hr has a decomposition temperature of 138° C. and 2,5-dimethyl-2,5-di-(t-butylperoxy)hexyne-3 at t_{1/2}=0.1 hr has a decomposition temperature of 182° C. Two or more cross-linking agents having different characteristic decomposition temperatures at the same t_{1/2} may be blended in the composition. For example, where at least one cross-linking agent has a first characteristic decomposition temperature less than 150° C., and at least one cross-linking agent has a second characteristic decomposition temperature greater than 150° C., the composition weight ratio of the at least one cross-linking agent having the first characteristic decomposition temperature to the at least one cross-linking agent having the second characteristic decomposition temperature can range from 5:95 to 95:5, or more preferably from 10:90 to 50:50.

Further, the peptizer, if present, preferably includes an organic sulfur compound, a metal salt of an organic sulfur compound, a non-metal salt of an organic sulfur compound, or combinations of those. In addition, the peptizer, if present, is present in an amount in the range of from about 0.01 to about 10 parts, and more preferably from about 0.1 to about 7 parts, by weight per 100 parts by weight of the unsaturated polymer component. Further, the peptizer, if present, is selected from organic sulfur compounds, metal salts of an organic sulfur compound, non-metal salt of an organic sulfur compound, and combinations thereof. More preferably, the peptizer, if present, is selected from pentachlorothiophenol, dibenzamido diphenyldisulfide, tetrachlorothiopyridine, a metal salt of tetrachlorothiopyridine, a metal salt of pentachlorothiophenol, an ammonium salt of pentachlorothiophenol with the ammonium cation having the general formula [NR¹R²R³R⁴]⁺ where R¹, R², R³, and R⁴ is either hydrogen or a C₁-C₂₀ aliphatic, cycloaliphatic or aromatic system, and combinations thereof. Most preferably, the peptizer, if present, is selected from pentachlorothiophenol, the zinc salt of pentachlorothiophenol, the NH₄⁺ salt of pentachlorothiophenol, tetrachlorothiopyridine, a metal salt of tetrachlorothiopyridine, and combinations thereof and is present in an amount of from about 0.10 to about 5 parts by weight per 100 parts by weight of the unsaturated polymer component.

Further, the accelerator, if present, preferably is present in an amount of from about 0.1 to about 10 parts, more preferably from about 0.2 to about 5 parts, and most preferably from about 0.5 to about 1.5 parts, by weight per 100 parts by weight of the unsaturated polymer. The accelerator preferably is selected from 2-mercaptobenzothiazole and a salt of 2-mercaptobenzothiazole.

Finally, the filler, if present, preferably is selected from precipitated hydrated silica, limestone, clay, talc, asbestos, barytes, glass fibers, aramid fibers, mica, calcium metasilicate, barium sulfate, zinc oxide, zinc sulfide, lithopone, silicates, silicon carbide, diatomaceous earth, carbonates such as calcium or magnesium or barium carbonate, sulfates such as calcium or magnesium or barium sulfate, metals, including tungsten steel copper, cobalt or iron, metal alloys, tungsten carbide, metal oxides, metal stearates, other particulate carbonaceous materials, and combinations thereof.

In yet another more detailed feature of this invention, the composition of the core or the core layer can comprise at least one hardness-enhancing material, the hardness enhancing material including at least a quantity of continuous or non-continuous fiber elements. Examples of fiber elements that can be used in the inner mantle layer and/or the outer mantle layer include fiber elements selected from glass fiber elements, carbon fiber elements, aramid fiber elements, and metallic fiber elements. The latter can include copper, high tensile steel, and stainless steel fiber elements.

In preferred embodiments, the quantity of fiber elements include from about 1 weight percent to about 50 weight percent of the outer core layer, inner mantle layer and/or the outer mantle layer, preferably from about 5 weight percent to about 40 weight percent of the outer core layer, the inner mantle layer and/or the outer mantle layer, more preferably from about 10 weight percent to about 30 weight percent of the outer core layer, the inner mantle layer and/or the outer mantle layer, and even more preferably from about 15 weight percent to about 20 weight percent of the outer core layer, the inner mantle layer and/or the outer mantle layer.

In yet another more detailed feature of this invention, the composition of the core or the core layer can comprise one or more nanofillers substantially dispersed in the thermoplastic or thermoset matrix polymer. Nanofillers comprise particles of inorganic material having a largest dimension that is about one micron or less and that is at least an order of magnitude greater than such particle's smallest dimension.

More particularly, the nanofiller is present in the thermoplastic or thermoset polymer in an amount of from about 0.1% to 20%, preferably from about 0.1% to about 15%, even more preferably from about 0.1% to about 10%, and most preferably from about 0.5% to about 5% by weight.

Even more particularly, the nanofiller is dispersed in the thermoplastic or thermoset matrix polymer in an intercalated or exfoliated manner.

### B. Intermediate Layer(s) and Cover Layer

The one or more intermediate layers of the golf balls of the present invention has a thickness of from about 0.01 to about 0.20 inch, preferably from about 0.02 to about 0.15 inch, more preferably from about 0.025 to about 0.10 inch and most preferably from about 0.03 to about 0.06 inch.

The one or more intermediate layers of the golf balls of the present invention also has a Shore D hardness greater than about 20, preferably greater than about 30, and typically greater than about 40.

The one or more intermediate layers of the golf balls of the present invention has a flexural modulus from about 1 to about 500 kpsi, preferably from about 5 to about 300 kpsi, more preferably from about 10 to about 200 kpsi, and most preferably from about 15 to about 150 kpsi.

One disclosed ball construction, referred to as ball construction I, preferably has the following characteristics:

Flexural modulus of Core material (F1)<30 kpsi;

Flexural modulus of Outer Core or Inner Mantle material (F2) in the range of 5-60 kpsi;

Flexural modulus of Outer Mantle material (F3) in the range of 30-130 kpsi These moduli satisfy the following:

F1<F2<F3;

F1<F2 at least by 3, preferably by 5, more preferably by 10 kpsi; and

F2<F3 at least by 3, preferably by 5, more preferably by 10 kpsi.

In more detailed features:

Compression of Core (C1) typically is in the range of 10-100;

Compression of Core and Outer Core (C2) is in the range of 40-90;

Compression of Core, Outer core or Inner Mantle, and Outer Mantle (C3) is in the range of 60-120; and

Compression of Ball (C4) is in the range of 70-130.

These compression values satisfy the following inequalities:

C1<C2<C3;

C1<C2 at least by 5, more preferably by 10, and most preferably by 15 compression units;

C2<C3 at least by 5, more preferably by 10, and most preferably by 15 compression units; and

C3-C4<10 compression units.

The inner mantle layer has a thickness of less than 0.15 inches and a Shore D hardness in the range of from about 20 to about 70, and the outer mantle layer has a thickness in the range of from about 0.010 to about 0.15 inches and a Shore D hardness in the range of from about 30 to about 90. In addition, the Shore D hardness value of the outer mantle layer exceeds that of the inner mantle layer by at least 3.

In more detailed features of the invention, the thickness of the inner mantle layer more preferably is less than 0.10 inches, more preferably still is less than 0.08 inches, and most preferably is less than 0.07 inches. In addition, the Shore D hardness of the inner mantle layer more preferably is in the range of from about 25 to about 65, more preferably still is in the range of from about 30 to about 65, and most preferably is from about 35 to about 60. Further, the thickness of the outer mantle layer more preferably is in the range of from about 0.015 to about 0.10 inches, more preferably still is in the range of from about 0.02 to about 0.08 inches, and most preferably is in the range of from about 0.025 to about 0.075 inches. In addition, the Shore D hardness value of the outer mantle layer more preferably is in the range of from about 35 to about 85, more preferably still is in the range of from about 40 to about 80, and most preferably is from about 45 to 75. Further, the Shore D hardness value of the outer mantle layer more preferably exceeds that of the inner mantle layer by at least 3, and most preferably by at least 5.

A second disclosed ball construction, referred to as ball construction II, preferably has the following characteristics:

Flexural modulus of Core material (F1)<30 kpsi;

Flexural modulus of Outer core or Inner Mantle material (F2) in the range of from about 25 to about 130 kpsi; and

Flexural modulus of Outer Mantle material (F3) in the range of from about 5 to about 60 kpsi.

These moduli satisfy the inequality that F2≧F3.

In more detailed features of the invention:

Compression of Core (C1) is in the range of from about 10 to about 100;

Compression of Core and Inner Mantle (C2) is in the range of from about 60 to about 120;

Compression of Core, Outer core or Inner Mantle, and Outer Mantle (C3) is in the range of from about 60 to about 120; and

Compression of Ball (C4) is in the range of about 70 to about 130.

These compression values satisfy the following inequalities:
C1<C2≧C3-5, preferably C1<C2≧C3-10;
C1<C2 at least by 5, more preferably by 10, and most preferably by 15 compression units; and
C3-C4<5 compression units.

The inner mantle layer has a thickness of less than 0.1 inches and a Shore D hardness in the range of from about 30 to about 90, and the outer mantle layer has a thickness in the range of from about 0.010 to about 0.10 inch and a Shore D hardness in the range of from about 20 to about 70. In addition, Shore D hardness value of the inner mantle layer exceeds that of the outer mantle layer by at least 3.

In more detailed features of the invention, the thickness of the inner mantle layer more preferably is less than 0.10 inches, more preferably still is less than 0.08 inches, and most preferably is less than 0.07 inches. In addition, the Shore D hardness of the inner mantle layer more preferably is in the range of from about 35 to about 85, more preferably still is in the range of from about 40 to about 80, and most preferably is from about 45 to about 75. Further, the thickness of the outer mantle layer preferably is in the range of from about 0.015 to about 0.10 inch, more preferably still is in the range of from about 0.02 to about 0.08 inches, and most preferably is in the range of from about 0.025 to about 0.075 inches. In addition, the Shore D hardness value of the outer mantle layer more preferably is in the range of from about 25 to about 65, more preferably still is in the range of from about 30 to about 65, and most preferably is from about 35 to 60. Further, the Shore D hardness value of the inner mantle layer more preferably exceeds that of the outer mantle layer by at least 3, and most preferably by at least 5.

In yet other more detailed features of the invention at least one outer core layer and mantle layer includes an ionomeric polymer that comprises:
(a) an ionomeric polymer comprising one or more E/X/Y copolymers, wherein E is ethylene, X is a C₃ to C₈ α,β ethylenically unsaturated carboxylic acid, and Y is a softening comonomer selected from alkyl acrylate and alkyl methacrylate, wherein the alkyl groups have from 1 to 8 carbon atoms, or ionomers of such E/X/Y copolymers, wherein X is in the range of from about 5 to about 35 weight % of the E/X/Y copolymer and Y is in the range of from 0 to about 50 weight % of the E/X/Y copolymer, and wherein the acid groups present in said ionomeric polymer are partially neutralized with a metal selected from zinc, sodium, lithium, calcium, magnesium, and combinations thereof; or
(b) a bimodal ionomeric polymer comprising:
   (i) a high molecular weight component having a molecular weight in the range of from about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said high molecular weight component is partially neutralized with metal ions selected from lithium, sodium, zinc, calcium, magnesium, and combinations thereof, and
   (ii) a low molecular weight component having a molecular weight in the range of from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said low molecular weight component is partially neutralized with metal ions selected from lithium, sodium, zinc, calcium, magnesium, and combinations thereof; or
(c) a modified ionomeric polymer comprising:
   (i) a blend composition comprising:
      ethylene,
      from about 5 to about 25 weight percent (meth)acrylic acid (based on the total weight of said modified ionomeric polymer), and
      from 0 to about 40 weight percent of a C₁ to C₈-alkyl acrylate (based on the total weight of said modified ionomeric polymer), and
      from about 5 to about 45 weight percent (based on the total weight of said modified ionomeric polymer) of a fatty acid or one or more metal salts of a fatty acid, or
   (ii) a bimodal polymer blend composition comprising:
      a high molecular weight component having a molecular weight in the range of from about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said high molecular weight component is partially neutralized with metal ions selected lithium, sodium, zinc, calcium, magnesium, and combinations thereof,
      a low molecular weight component having a molecular weight in the range of from about 2,000 to about 30,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein said low molecular weight component is partially neutralized with metal ions selected from lithium, sodium, zinc, calcium, magnesium, and combinations thereof, and
      from about 5 to about 45 weight percent (based on the total weight of said modified ionomeric polymer) of a fatty acid or one or more metal salts of a fatty acid; or
(d) a blend composition comprising the reaction product of:
   (i) one or more ionomers, and
   (ii) a compound having a general formula (R₂N)ₘ—R′—(X(O)ₙOR_{y})ₘ, where R is selected from hydrogen, one or more C₁-C₂₀ aliphatic systems, one or more cycloaliphatic systems, one or more aromatic systems, and combinations thereof, R′ is a bridging group comprising one or more unsubstituted C₁-C₂₀ straight chain or branched aliphatic or alicyclic groups, or one or more substituted straight chain or branched aliphatic or alicyclic groups, or one or more aromatic groups, or one or more oligomers each containing up to 12 repeating units, and wherein when X=C or S or P, m is 1-3, when X=C, n=1 and y=1, when X=S, n=2 and y=1, and when X=P, n=2 and y=2; or
(e) combinations of (a), (b), (c), and (d).

In yet other more detailed features of this invention, the composition of at least one outer core layer and mantle layer comprises polymer selected from the group consisting of thermoplastic resins, thermoset resins, thermoplastic polyurethane, thermoset polyurethane, polyamide elastomer, thermoplastic copolyetherester block copolymer, thermoplastic copolyesterester block copolymer, polyethylene-octene, polybutylene-octene, polyoctenamer, polyisoprene, 1,2-syndiotactic polybutadiene, thermoplastic vulcanizate, copolymeric ionomer, terpolymeric ionomer, polyurethane ionomer, polyamide ionomer, polycarbonate, polyolefin, polyamide, copolymeric polyamide, polyester, polyvinyl alcohol, acrylonitrile-butadiene-styrene copolymer, polyarylate, polyacrylate, polyphenylene ether, impact-modified polyphenylene ether, high impact polystyrene, diallyl phthalate polymer, metallocene catalyzed polymer, styrene-acrylonitrile (SAN) (including olefin-modified SAN and acrylonitrile-styrene-acrylonitrile), styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, polysiloxane, and combinations thereof.

In yet other more detailed features of the invention, the one or more core layers, or mantle layers can include polymer composition comprising (1) at least one unsaturated polymer, (2) at least one cross-linking agent, (3) at least one co-cross-linking agent, (4) optionally at least one peptizer, (5) optionally at least one accelerator, and (6) optionally at least one filler. The unsaturated polymer is selected from polyoctenamer, 1,2-polybutadiene, cis-1,4-polybutadiene, trans-1,4-polybutadiene, cis-polyisoprene, trans-polyisoprene, polychloroprene, polybutylene, styrene-butadiene rubber, styrene-butadiene-styrene block copolymer and partially hydrogenated equivalents, styrene-isoprene-styrene block copolymer and partially and hydrogenated equivalents, nitrile rubber, silicone rubber, and polyurethane, and combinations thereof. Polybutadiene rubbers, especially 1,4-polybutadiene rubbers containing at least 40 mol %, and more preferably 80 to 100 mol % of cis-1,4 bonds, are preferred because of their high rebound resilience, moldability, and high strength after vulcanization. The polybutadiene component may be synthesized by using rare earth-based catalysts, nickel-based catalysts, or cobalt-based catalysts, conventionally used in this field. Polybutadiene obtained by using lanthanum rare earth-based catalysts usually employ a combination of a lanthanum rare earth (atomic number of 57 to 71) compound, but particularly preferred is a neodymium compound.

The 1,4-polybutadiene rubbers have a molecular weight distribution (Mw/Mn) of from about 1.2 to about 4.0, preferably from about 1.7 to about 3.7, even more preferably from about 2.0 to about 3.5, most preferably from about 2.2 to about 3.2. The polybutadiene rubbers have a Mooney viscosity (ML₁₊₄(100° C.)) of from about 20 to about 80, preferably from about 30 to about 70, even more preferably from about 30 to about 60, most preferably from about 35 to about 50. The term “Mooney viscosity” as used herein refers in each case to an industrial index of viscosity as measured with a Mooney viscometer, which is a type of rotary plastometer (see JIS K6300). This value is represented by the symbol ML₁₊₄ (100° C.), wherein “M” stands for Mooney viscosity, “L” stands for large rotor (L-type), “1+4” stands for a pre-heating time of 1 minute and a rotor rotation time of 4 minutes, and “100° C.” indicates that measurement was carried out at a temperature of 100° C.

Examples of suitable polyalkenamer rubbers are polypentenamer rubber, polyheptenamer rubber, polyoctenamer rubber, polydecenamer rubber and polydodecenamer rubber. For further details concerning polyalkenamer rubber, see Rubber Chem. & Tech., Vol. 47, page 511-596, 1974, which is incorporated herein by reference. Polyoctenamer rubbers are commercially available from Huls AG of Marl, Germany, and through its distributor in the U.S., Creanova Inc. of Somerset, N.J., and sold under the trademark VESTENAMER®. Two grades of the VESTENAMER® trans-polyoctenamer are commercially available: VESTENAMER 8012 designates a material having a trans-content of approximately 80% (and a cis-content of 20%) with a melting point of approximately 54° C.; and VESTENAMER 6213 designates a material having a trans-content of approximately 60% (cis-content of 40%) with a melting point of approximately 30° C. Both of these polymers have a double bond at every eighth carbon atom in the ring.

Preferable cross-linking agents include peroxides, sulfur compounds, as well as mixtures of these. Non-limiting examples of suitable cross-linking agents include primary, secondary, or tertiary aliphatic or aromatic organic peroxides. Peroxides containing more than one peroxy group can be used, such as 2,5-dimethyl-2,5-di(tert-butylperoxy)hexane and 1,4-di-(2-tert-butyl peroxyisopropyl)benzene. Both symmetrical and asymmetrical peroxides can be used, for example, tert-butyl perbenzoate and tert-butyl cumyl peroxide. Peroxides incorporating carboxyl groups also are suitable. The decomposition of peroxides used as cross-linking agents in the disclosed compositions can be brought about by applying thermal energy, shear, irradiation, reaction with other chemicals, or any combination of these. Both homolytically and heterolytically decomposed peroxide can be used. Non-limiting examples of suitable peroxides include: diacetyl peroxide; di-tert-butyl peroxide; dibenzoyl peroxide; dicumyl peroxide; 2,5-dimethyl-2,5-di(benzoylperoxy)hexane; 1,4-bis-(t-butylperoxyisopropyl)benzene; t-butylperoxybenzoate; 2,5-dimethyl-2,5-di-(t-butylperoxy)hexyne-3, such as Trigonox 145-45B, marketed by AkzoNobel, with corporate headquarters in Amsterdam; 1,1-bis(t-butylperoxy)-3,3,5 tri-methylcyclohexane, such as Varox 231-XL, marketed by R.T. Vanderbilt Co., Inc. of Norwalk, Conn.; and di-(2,4-dichlorobenzoyl)peroxide. Each peroxide cross-linking agent has a characteristic decomposition temperature at which 50% of the cross-linking agent has decomposed when subjected to that temperature for a specified time period (t_{1/2}). For example, 1,1-bis-(t-butylperoxy)-3,3,5-tri-methylcyclohexane at t_{1/2}=0.1 hr has a decomposition temperature of 138° C. and 2,5-dimethyl-2,5-di-(t-butylperoxy)hexyne-3 at t_{1/2}=0.1 hr has a decomposition temperature of 182° C. Two or more cross-linking agents having different characteristic decomposition temperatures at the same t_{1/2} may be blended in the composition. For example, where at least one cross-linking agent has a first characteristic decomposition temperature less than 150° C., and at least one cross-linking agent has a second characteristic decomposition temperature greater than 150° C., the composition weight ratio of the at least one cross-linking agent having the first characteristic decomposition temperature to the at least one cross-linking agent having the second characteristic decomposition temperature can range from 5:95 to 95:5, or more preferably from 10:90 to 50:50.

Further, the peptizer, if present, preferably includes an organic sulfur compound, a metal salt of an organic sulfur compound, a non-metal salt of an organic sulfur compound, or combinations of those. In addition, the peptizer, if present, is present in an amount in the range of from about 0.01 to about 10 parts, and more preferably from about 0.1 to about 7 parts, by weight per 100 parts by weight of the unsaturated polymer component. Further, the peptizer, if present, is selected from organic sulfur compounds, metal salts of an organic sulfur compound, non-metal salts of an organic sulfur compound, and combinations thereof. More preferably, the peptizer, if present, is selected from pentachlorothiophenol, dibenzamido diphenyldisulfide, tetrachlorothiopyridine, a metal salt of tetrachlorothiopyridine, a metal salt of pentachlorothiophenol, an ammonium salt of pentachlorothiophenol with the ammonium cation having the general formula [NR¹R²R³R⁴]⁺ where R¹, R², R³, and R⁴ is either hydrogen, or a C₁-C₂₀ aliphatic, cycloaliphatic or aromatic system, and combinations thereof. Most preferably, the peptizer, if present, is selected from pentachlorothiophenol, the zinc salt of pentachlorothiophenol, the NH₄⁺ salt of pentachlorothiophenol, tetrachlorothiopyridine, a metal salt of tetrachlorothiopyridine, and combinations thereof, and is present in an amount of from about 0.10 to about 5 parts by weight per 100 parts by weight of the unsaturated polymer component.

Further, the accelerator, if present, preferably is present in an amount of from about 0.1 to about 10 parts, more preferably from about 0.2 to about 5 parts, and most preferably from about 0.5 to about 1.5 parts, by weight per 100 parts by weight of the unsaturated polymer. The accelerator preferably is selected from 2-mercaptobenzothiazole and a salt of 2-mercaptobenzothiazole.

Finally, the filler, if present, preferably is selected from precipitated hydrated silica, limestone, clay, talc, asbestos, barytes, glass fibers, aramid fibers, mica, calcium metasilicate, barium sulfate, zinc oxide, zinc sulfide, lithopone, silicates, silicon carbide, diatomaceous earth, carbonates such as calcium or magnesium or barium carbonate, sulfates such as calcium or magnesium or barium sulfate, metals, including tungsten steel copper, cobalt or iron, metal alloys, tungsten carbide, metal oxides, metal stearates, other particulate carbonaceous materials, and combinations thereof.

In yet another more detailed feature of this invention, the composition of the outer core layer, the inner mantle layer and/or the outer mantle layer can comprise at least one hardness-enhancing material, the hardness enhancing material including at least a quantity of continuous or non-continuous fiber elements. The fiber elements that can be used in the inner mantle layer and/or the outer mantle layer include fiber elements selected from glass fiber elements, carbon fiber elements, aramid fiber elements, and metallic fiber elements. The latter can include copper, high tensile steel, and stainless steel fiber elements.

In preferred embodiments, the quantity of fiber elements include from about 1 weight percent to about 50 weight percent of the outer core layer, inner mantle layer and/or the outer mantle layer, preferably from about 5 weight percent to about 40 weight percent of the outer core layer, the inner mantle layer and/or the outer mantle layer, more preferably from about 10 weight percent to about 30 weight percent of the outer core layer, the inner mantle layer and/or the outer mantle layer, and even more preferably from about 15 weight percent to about 20 weight percent of the outer core layer, the inner mantle layer and/or the outer mantle layer.

In yet another more detailed feature of this invention, the composition of the outer core layer, the inner mantle layer and/or the outer mantle layer can comprise one or more nanofillers substantially dispersed in the thermoplastic or thermoset matrix polymer. Nanofiller comprises particles of inorganic material having a largest dimension that is about one micron or less and that is at least an order of magnitude greater than such particle's smallest dimension.

More particularly, the nanofiller is present in the thermoplastic or thermoset polymer in an amount of from about 0.1% to about 20%, preferably from about 0.1% to about 15%, even more preferably from about 0.1% to about 10%, and most preferably from about 0.5% to about 5% by weight.

Even more particularly, the nanofiller is dispersed in the thermoplastic or thermoset matrix polymer in an intercalated or exfoliated manner.

The cover layer of the balls of the present invention has a thickness of from about 0.01 to about 0.10 inch, preferably from about 0.02 to about 0.09 inch, more preferably from about 0.025 to about 0.08 inch, and most preferably from about 0.030 to about 0.07 inch.

The cover layer of the balls of the present invention has a Shore D hardness of from about 30 to about 75, preferably from about 30 to about 70, more preferably from about 35 to about 65.

The coefficient of restitution (COR) is an important physical attribute of golf balls. The coefficient of restitution is the ratio of the relative velocity between two objects after direct impact to the relative velocity before impact. As a result, the COR can vary from 0 to 1, with 1 being a perfectly or completely elastic collision and 0 being a perfectly or completely inelastic collision. Since the COR directly influences the ball's initial velocity after club collision and travel distance, golf ball manufacturers are interested in this characteristic for designing and testing golf balls.

In the present invention, the coefficient of restitution (COR) is greater than 0.700 at 125 ft/sec or 143 ft/sec inbound velocity.

### III. Disclosed Compositions

As stated above, the present invention concerns a crosslinked resin composition comprising at least one functionalized polymeric material having a hydroxyl group or groups, an amine functional group or groups, or both hydroxyl and amine functional groups, and at least one modified polyisocyanate. The functionalized polymeric material(s) can have a plurality of active hydroxyl groups, a plurality of amino functional groups, or both hydroxyl and amino functional groups. At least one, more than one, or all of the hydroxyl and/or amino functional groups of the polymeric material react with the modified polyisocyanate or modified polyisocyanates to form urethane, urea or urethane/urea linkages.

Examples of hydroxyl- and/or amine-functionalized polymeric materials include, without limitation, poly(vinyl alcohol), poly(ethylene vinyl alcohol) copolymer, poly(2-hydroxylethyl methacrylate), poly(allylamine), poly(ethyleneimine), poly(4-vinylphenol), hydroxyl-terminated styrene butadiene styrene (SBS) triblock copolymer, hydroxyl-terminated styrene isoprene styrene (SIPS) triblock copolymer, and hydroxyl end-capped poly(1,4-butylene adipate). The hydroxyl group or groups of the polymeric material may be primary functional groups, secondary functional groups, or the polymeric material may include combinations of both primary and secondary hydroxyl groups. Likewise, the amine functional groups of the polymeric material include primary functional groups, secondary functional groups, or combinations of both primary and secondary amine functional groups.

For disclosed embodiments, the resin composition comprises a functionalized thermoplastic urethane, urea, urethane/urea comprising at least one hydroxyl functional group, at least one amine functional group, or both at least one hydroxyl group and at least one amine functional group, and at least one modified polyisocyanate. The functionalized thermoplastic urethane, urea, or urethane/urea is the reaction product of any polyol, polyamine, or polyol polyamine, a polyisocyanate, such as a diisocyanate, and a chain extender.

Any currently known polyol, or future developed polyol, particularly those known to one of ordinary skill in the polyurethane art, is suitable for use according to the invention. Polyols suitable for disclosed embodiments of the present invention, such as for use in reduced-yellowing compositions include, but are not limited to, polyester polyols, polyether polyols, polycarbonate polyols and polydiene polyols, such as polybutadiene polyols.

Polyester polyols typically are prepared by condensation or step-growth polymerization utilizing diacids. Primary diacids for polyester polyols are adipic acid and isomeric phthalic acids. Adipic acid is used for materials requiring added flexibility, whereas phthalic anhydride is used for those requiring rigidity. Some examples of polyester polyols include poly(ethylene adipate) (PEA), poly(diethylene adipate) (PDA), poly(propylene adipate) (PPA), poly(tetramethylene adipate) (PBA), poly(hexamethylene adipate) (PHA), poly(neopentylene adipate) (PNA), polyols composed of 3-methyl-1,5-pentanediol and adipic acid, random copolymers of PEA and PDA, random copolymer of PEA and PPA, random copolymers of PEA and PBA, random copolymers of PHA and PNA, caprolactone polyols obtained by ring-opening polymerization of ε-caprolactone, and polyols obtained by ring opening of β-methyl-δ-valerolactone with ethylene glycol. Additionally, polyester polyols may comprise a copolymer of at least one acid and at least one glycol. Exemplary acids include terephthalic acid, isophthalic acid, phthalic anhydride, oxalic acid, malonic acid, succinic acid, pentanedioic acid, hexanedioic acid, octanedioic acid, nonanedioic acid, adipic acid, azelaic acid, sebacic acid, dodecanedioic acid, dimer acid (a mixture), ρ-hydroxybenzoate, trimellitic anhydride, ε-caprolactone, and β-methyl-δ-valerolactone. Exemplary glycols include aliphatic and cyclic aliphatic glycols, such as ethylene glycol, propylene glycol, butylene glycol, pentylene glycol, 1,4-butanediol, 1,5-pentanediol, 1,6-hexanediol, neopentylene glycol, polyethylene glycol, polytetramethylene glycol, 1,4-cyclohexane dimethanol, pentaerythritol, and 3-methyl-1,5-pentanediol.

Polyether polyols typically are prepared by ring-opening addition polymerization of an alkylene oxide (e.g. ethylene oxide and propylene oxide) with an initiator of a polyhydric alcohol (e.g. diethylene glycol), which is an active hydride. Specifically, polypropylene glycol (PPG), polyethylene glycol (PEG) or propylene oxide-ethylene oxide copolymer can be obtained. Polytetramethylene ether glycol (PTMG) is prepared by the ring-opening polymerization of tetrahydrofuran, produced by dehydration of 1,4-butanediol or hydrogenation of furan. Tetrahydrofuran can form a copolymer with alkylene oxide. Specifically, tetrahydrofuran-propylene oxide copolymer or tetrahydrofuran-ethylene oxide copolymer can be formed.

Polycarbonate polyols typically are obtained by condensation of a known polyol (polyhydric alcohol) with phosgene, chloroformic acid ester, dialkyl carbonate or diallyl carbonate. Particularly preferred polycarbonate polyols contains a polyol component using 1,6-hexanediol, 1,4-butanediol, 1,3-butanediol, neopentylglycol or 1,5-pentanediol. Polydiene polyols include liquid diene polymers containing hydroxyl groups having an average of at least 1.7 functional groups, and may be composed of a diene polymer or a diene copolymer having from about 4 to about 12 carbon atoms, or a copolymer of such diene with addition to polymerizable α-olefin monomer having 2 to 2.2 carbon atoms. Specific examples include butadiene homopolymer, isoprene homopolymer, butadiene-styrene copolymer, butadiene-isoprene copolymer, butadiene-acrylonitrile copolymer, butadiene-2-ethyl hexyl acrylate copolymer, and butadiene-n-octadecyl acrylate copolymer. These liquid diene polymers can be obtained, for example, by heating a conjugated diene monomer in the presence of hydrogen peroxide in a liquid reactant.

Any currently known polyamine, or future developed polyamine, particularly those known to one of ordinary skill in the polyurea art, is suitable for use according to the invention. Polyamines suitable for use in the compositions of the present invention include, but are not limited to, 3,5-dimethylthio-2,4-toluenediamine; 3,5-dimethylthio-2,6-toluenediamine; N,N′-dialkyldiamino diphenyl methane; trimethylene-glycol-di-p-aminobenzoate; polytetramethyleneoxide-di-p-aminobenzoate, and mixtures thereof. Of these, 3,5-dimethylthio-2,4-toluenediamine and 3,5-dimethylthio-2,6-toluenediamine are isomers and are sold under the trade name ETHACURE® 300 by Ethyl Corporation. Trimethylene glycol-di-p-aminobenzoate is sold under the trade name POLACURE 740M and polytetramethyleneoxide-di-p-aminobenzoates are sold under the trade name POLAMINES by Polaroid Corporation. N,N′-dialkyldiamino diphenyl methane is sold under the trade name UNILINK® by UOP. Suitable fast-reacting curing agent can be used include diethyl-2,4-toluenediamine, 4,4″-methylenebis-(3-chloro,2,6-diethyl)-aniline (available from Air Products and Chemicals Inc., of Allentown, Pa., under the trade name LONZACURE®), 3,3′-dichlorobenzidene; 3,3′-dichloro-4,4′-diaminodiphenyl methane (MOCA); N,N,N′,N′-tetrakis(2-hydroxypropyl)ethylenediamine and Curalon L, a trade name for a mixture of aromatic diamines sold by Uniroyal, Inc. or any and all combinations thereof. A preferred fast-reacting curing agent is diethyl-2,4-toluene diamine, which has two commercial grades names, Ethacure® 100 and Ethacure® 100LC commercial grade has lower color and less by-product. Blends of fast and slow curing agents are especially preferred.

Preferably the amine-terminated compound is selected from amine-terminated hydrocarbons, amine-terminated polyethers, amine-terminated polyesters, amine-terminated polycaprolactones, amine-terminated polycarbonates, amine-terminated polyamides, and mixtures thereof. The amine-terminated compound may be a polyether amine selected from the group consisting of polytetramethylene ether diamines, polyoxypropylene diamines, poly(ethylene oxide capped oxypropylene) ether diamines, triethyleneglycoldiamines, propylene oxide-based triamines, trimethylolpropane-based triamines, glycerin-based triamines, and mixtures thereof.

Especially preferred amines include MDA (4,4′-methylene dianiline), 1,12-dodecanediamine, acetoguanamine (6-methyl-1,3,5-triazine-2,4-diamine), benzoguanamine, and its derivative of guanamine.

Polyols and/or polyamines can be used alone or in any and all combinations.

Any currently known polyisocyanate, typically diisocyanates, or future developed polyisocyanate, particularly those available to one of ordinary skill in the polyurethane/polyurea art, is suitable for use according to disclosed embodiments of the present invention. Examples of diisocyanates which can be used include, without limitation: 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

Any currently known or future developed chain extender, particularly those known to one of ordinary skill in the polyurethane/polyurea art, is suitable for use according to disclosed embodiments of the present invention. Chain extenders suitable for use in the compositions of the present invention include, but are not limited to, 1,2-ethylene glycol, 1,3-butane diol, 1,4-butylene glycol, 1,6-hexane diol, 2,2-dimethyl-1,3-propane diol, 4,4′-diaminodiphenylmethane, hydrogenated MDA, isophorone diamine, hexamethylenediamine, and hydroquinone diethylol ether.

Generally, a thermoplastic polyurethane, polyurea, or polyurethane/urea composition comprises a diisocyanate, polyol and/or polyamine, and a chain extender. The equivalent ratio between isocyanate functional groups and hydroxyl and/or amine functional groups of the polyol and/or polyamine in the polyurethane, polyurea, or polyurethane/urea to form a thermoplastic resin is controlled to be no less than 1.0 and no greater than 1.3. If the equivalent ratio (NCO/OH, NCO/NH₂ or NCO/OH+NH₂) of the isocyanate group of the isocyanate to the hydroxyl group of the polyol (or amine group of the polyamine) is less than the lower limit, an insufficient amount of isocyanate relative to hydroxyl group (or amine group) may produce materials having poor mechanical properties. Moreover, if the equivalent ratio of isocyanate-to-hydroxyl group (NCO/OH) or isocyanate-to-amine group (NCO/NH₂) is greater than the upper limit, an excess of isocyanate functional group to hydroxyl and/or amine group may produce a composition that has poor flowability and is too moisture sensitive.

The equivalent ratio of functionalized thermoplastic polyurethane, polyurea, polyurethane/urea for use with the present invention is controlled to be from 0.6 to 1.03, preferably from 0.75 to 1.02, more preferably from 0.85 to 1.01. Thus, the functionalized thermoplastic polyurethanes have remaining reactive hydroxyl groups, amine groups, or both, that can react with modified polyisocyanates. Suitable functionalized thermoplastic polyurethanes were obtained from Lubrizol Advance Materials and BASF Corporations.

The modified polyisocyanate has at least three isocyanate functional groups, which can include one or more blocked isocyanate functional groups that is formed by a reaction between two or multiple isocyanates. The linkage formed by the two or multiple isocyanates includes uretdione, isocyanurate, or biuret moieties.

The modified polyisocyanates can be formed using any suitable isocyanate, particularly diisocyanates and/or triisocyanates, including, without limitation: 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylene diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate; dodecane-1,12-diisocyanate; 1,10-decamethylene diisocyanate; cyclohexylene-1,2-diisocyanate; 1,10-decamethylene diisocyanate; 1-chlorobenzene-2,4-diisocyanate; furfurylidene diisocyanate; 2,4,4-trimethyl hexamethylene diisocyanate; 2,2,4-trimethyl hexamethylene diisocyanate; dodecamethylene diisocyanate; 1,3-cyclopentane diisocyanate; 1,3-cyclohexane diisocyanate; 1,3-cyclobutane diisocyanate; 1,4-cyclohexane diisocyanate; 4,4′-methylenebis(cyclohexyl isocyanate); 4,4′-methylenebis(phenyl isocyanate); 1-methyl-2,4-cyclohexane diisocyanate; 1-methyl-2,6-cyclohexane diisocyanate; 1,3-bis (isocyanato-methyl)cyclohexane; 1,6-diisocyanato-2,2,4,4-tetra-methylhexane; 1,6-diisocyanato-2,4,4-tetra-trimethylhexane; trans-cyclohexane-1,4-diisocyanate; 3-isocyanato-methyl-3,5,5-trimethylcyclo-hexyl isocyanate; 1-isocyanato-3,3,5-trimethyl-5-isocyanatomethylcyclohexane; cyclo-hexyl isocyanate; dicyclohexylmethane 4,4′-diisocyanate; 1,4-bis(isocyanatomethyl)cyclohexane; m-phenylene diisocyanate; m-xylylene diisocyanate; m-tetramethylxylylene diisocyanate; p-phenylene diisocyanate; p,p′-biphenyl diisocyanate; 3,3′-dimethyl-4,4′-biphenylene diisocyanate; 3,3′-dimethoxy-4,4′-biphenylene diisocyanate; 3,3′-diphenyl-4,4′-biphenylene diisocyanate; 4,4′-biphenylene diisocyanate; 3,3′-dichloro-4,4′-biphenylene diisocyanate; 1,5-naphthalene diisocyanate; 4-chloro-1,3-phenylene diisocyanate; 1,5-tetrahydronaphthalene diisocyanate; metaxylene diisocyanate; 2,4-toluene diisocyanate; 2,4′-diphenylmethane diisocyanate; 2,4-chlorophenylene diisocyanate; 4,4′-diphenylmethane diisocyanate; p,p′-diphenylmethane diisocyanate; 2,4-tolylene diisocyanate; 2,6-tolylene diisocyanate; 2,2-diphenylpropane-4,4′-diisocyanate; 4,4′-toluidine diisocyanate; dianidine diisocyanate; 4,4′-diphenyl ether diisocyanate; 1,3-xylylene diisocyanate; 1,4-naphthylene diisocyanate; azobenzene-4,4′-diisocyanate, diphenyl sulfone-4,4′-diisocyanate; or mixtures thereof.

Exemplary modified polyisocyanates are selected from:

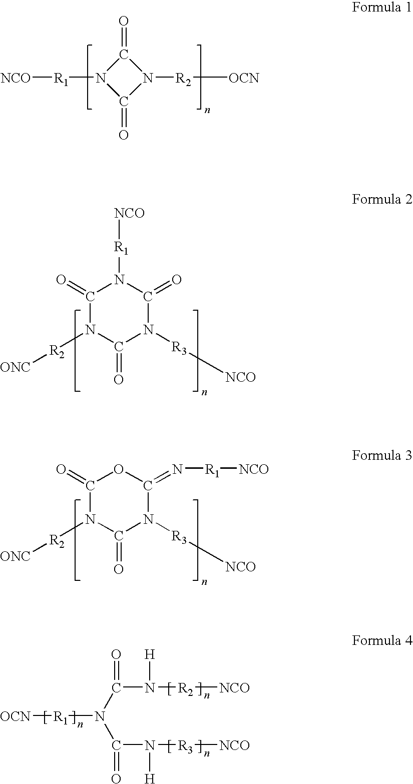

or mixtures thereof. With reference to general Formulas 1-4, n is 1 to 40, R₁, R₂, and R₃ independently are aliphatic; substituted aliphatic; cyclic aliphatic; aryl, such as phenyl; heteroaryl; or mixtures thereof. R₁, R₂, and R₃ more typically are alkyl, substituted alkyl, or cyclic alkyl groups having from 1 to at least about 20 carbon atoms.

Disclosed embodiments of modified polyisocyanates have at least two free reactive isocyanates available for a reaction during primary processing. Those free isocyanate participate in a reaction with any reactive nucleophilic functional group, such as hydroxyl, amino, and carboxylic acid functional groups. Additional isocyanate can be provided by dissociation of blocked isocyanate as disclosed in the modified polyisocyanates. For example, isocyanates linked by uretdione and isocyanurate groups can release reactive isocyanates by heating or by chemical reaction. A person of ordinary skill in the art will appreciate that this effective temperature can vary, but typically is from about 80 to about 250° C., and more typically is from about 100 to about 200° C. The dissociated isocyanate can react with functionalized groups such as hydroxyl or amine/amino groups to provide further crosslinking.

The composition in this invention comprises the modified polyisocyanate in amounts of from about 0.1 part to about 20 parts, preferably from about 0.5 part to 15 parts, more preferably from about 0.7 part to about 10 parts, and most preferably from about 1 part to about 8 parts based on the weight of functionalized polymer.

The degree of crosslinking is governed by the type and concentration of the modified polyisocyanate that is used in the composition. The modified polyisocyanate used in the composition preferably is selected, at least in part, to have a uretdione and/or an isocyanurate linkage. Particular examples of modified polyisocyanates include those marked under the trade name Mondur® and Desmodur® by Bayer MaterialScience Corporation. Examples of those include TDI based polyisocyanates, such as Desmodur® L, Desmodur® IL; MDI-based polyisocyanates, such as Mondur® CD, Mondur MR, Mondur® MRS, Mondur® MRS 4, Mondur® MRS 5, Desmodur® VL; HDI-based polyisocyanates, such as Desmodur® N-75, Desmodur® N-100, Desmodur® N-3200, which are polymeric materials containing biuret groups; Desmodur® N-3300, Desmodur® N-3390, Desmodur® N-3600, Desmodur® N-3790, Desmodur® N-3800, Desmodur® XP2410, which are polymeric materials containing isocyanurate groups; Desmodur® N-3400, which refers to polyisocyanate-containing uretdione groups; Desmodur® HL, which is TDI and HDI copolymer containing isocyanurate groups; IPDI-based polyisocyanates, such as Desmodur® Z grades; and HDI- and IPDI-based polyisocyanates, such as Desmodur® NZ-1. The modified polyisocyanates may be used alone or in combination with other polyisocyanate. When used in combination, a modified aromatic polyisocyanate is preferably combined with an aliphatic polyisocyanate. The mix ratio of aromatic/aliphatic modified polyisocyanate is from about 0.1:10 to about 10:0.1, more preferably from about 1:5 to about 5:1.

Another group of modified polyisocyanates that is suitable for use with disclosed embodiments of the present invention comprise blocked isocyanate groups. The isocyanate functional groups of these compounds can be blocked with any suitable blocking group, such as ε-caprolactam, butanone oxime, phenol, or dimethylpyrazole. These blocked polyisocyanates do not react at room temperature with polyols or polyamines. At elevated temperatures the blocked polyisocyanate reacts with polyol or polyamines as described in U.S. Pat. No. 6,939,924, which is incorporated herein by reference. Particular preferred examples of modified polyisocyanates include those marked under the trade name Desmodur® and Crelan® by Bayer MaterialScience Corporation.

Additionally, disclosed embodiments of the present composition, and products comprising the composition, may further comprise UV stabilizers, photostabilizers, antioxidants, colorants, dispersants, mold releasing agents, processing aids, fillers, a density adjusting filler, a nano-filler, an inorganic filler, an organic filler, and combinations thereof. Examples of fillers include precipitated hydrated silica, limestone, clay, talc, asbestos, barytes, glass fibers, aramid fibers, mica, calcium metasilicate, barium sulfate, zinc sulfide, lithopone, silicates, silicon carbide, diatomaceous earth, calcium carbonate, magnesium carbonate, barium carbonate, calcium sulfate, magnesium sulfate, barium sulfate, tungsten, steel, copper, cobalt, iron, metal alloys, tungsten carbide, zinc oxide, calcium oxide, barium oxide, titanium dioxide, metal stearates, particulate carbonaceous materials, nanofillers and any and all combinations thereof. Examples of nanofillers include inorganic clays selected from hydrotalcite, phyllosilicate, saponite, hectorite, beidellite, stevensite, vermiculite, halloysite, mica, montmorillonite, micafluoride, octosilicate, and combinations thereof. The nanofiller may be surface treated with a compatibilizer selected from hydroxy-, thiol-, amino-, epoxy-, carboxylic acid-, ester-, amide-, and siloxy-group containing compounds, oligomers, polymers and combinations thereof. The nanofiller may be intercalated within the polymeric material or exfoliated within the polymer.

### EXAMPLES

The following examples are provided to illustrate certain features of disclosed embodiments. A person of ordinary skill in the art will appreciate that the scope of the present invention is not limited to the particular features of such examples.

### Example 1

### A. Materials

TPU-1 (thermoplastic polyurethane elastomer-1): thermoplastic polyurethane elastomer made by Lubrizol Advanced Materials (the equivalent ratio (NCO/OH) is controlled as 95%).

TPU-2 (thermoplastic polyurethane elastomer-2): thermoplastic polyurethane elastomer made by BASF USA (the equivalent ratio is controlled to be as close to 100%).

Mondur® CD is a modified aromatic polyisocyanate based on 4,4′-diphenylmethane diisocyanate (MDI) made by Bayer MaterialScience.

Desmodur® N 3600 is a modified aliphatic polyisocyanate based on hexamethylene diisocyanate (HDI) made by Bayer MaterialScience.

Crelan NW 5 is an ε-caprolactam blocked polyisocyanate based on hydrogenated 4,4′-diphenylmethane diisocyanate (HMDI) made by Bayer MaterialScience.

### B. Test Methods

Tensile strength (psi) was measured by Universal Material Testing machines from Instron Corporations in accordance with ASTM Test D 368.

Tensile elongation (%) was measured by Universal Material Testing machines from Instron Corporations in accordance with ASTM Test D 368.

Flex modulus (kpsi) was measured by Universal Material Testing machines from Instron Corporations in accordance with ASTM Test D 790.

Material Hardness (Shore D) was measured by Shore instruments from Instron Corporations in accordance with ASTM Test D2240.

Taber loss was measured by Taber Abrasion tester at 1000 rev and 1 kg load.

Melt flow index was measured at 230° C. and 2160 g load by melt index tester.

Ball hardness (Shore D) was measured by Shore instruments from Instron Corporations in accordance with ASTM D1238.

Compression (PGA) was measured by Automated Design Corporation.

The shear durability test was done with an ADC machine having a steel-arm with a pitching wedge face having a 45-degree, loft-type striking plate (Arm speed: 110 fps) and the results classified using the following shear cut index:
1: No damage on the ball;
2: The golf ball surface has very slightly cut or not noticeable damage;
3: The golf ball surface has a cut but minor damage;
4: The golf ball surface is clearly cut and becomes fluffy; and
5: The golf ball surface is considerably damaged and becomes noticeably fluffy.

### C. Property Measurement

A series of trials were conducted on compositions with hydroxyl functionalized ether- or ester-type thermoplastic polyurethanes and various modified polyisocyanate, in which the type and concentration of the mixture of modified polyisocyanates were varied to demonstrate the effects of crosslinking on mechanical properties. The modified polyisocyanate was introduced to functionalized polyurethane using extrusion followed by injection molding to prepare the specimens discussed below. The extrusion temperature was from 180 to 200° C. and the injection molding temperature was from 220 to 240° C. Various tests were performed on these specimens, and the test results are summarized below in Table 1.

TABLE 1

| Material | #1 | #2 | #3 | #4 | #5 | #6 | #7 | #8 |
|---|---|---|---|---|---|---|---|---|
| TPU-1 | 100 | 100 | 100 | 100 | | | | |
| TPU-2 | | | | | 100 | 100 | 100 | 100 |
| Mondur ® | | 2.5 | 5 | 2.5 | | 2.5 | 5 | 2.5 |
| CD/Desmodur ® | | | | | | | | |
| N3600 = 2/1 | | | | | | | | |
| Crelan NW5 | | | | 1 | | | | 1 |
| Tensile Strength | 1778.2 | 4445.6 | 5124.28 | 4911.3 | 2876.6 | 4438.38 | 4388.6 | 4204.6 |
| (psi) | | | | | | | | |
| Tensile Elongation | 599.8 | 1175.6 | 947.78 | 1005.9 | 729.8 | 865.41 | 793.89 | 688.5 |
| (%) | | | | | | | | |
| Tensile E. Abs. (ft- | 99.0 | 368.9 | 340.1 | 351.4 | 159.0 | 266.81 | 250.71 | 214.5 |
| lb/in²) | | | | | | | | |
| Flexure Stress (psi) | 51.5 | 78.1 | 86.5 | 96.6 | 35.2 | 53.9 | 62.6 | 47.7 |
| Flexure Modulus | 6.4 | 8.7 | 9.9 | 11.1 | 4.3 | 6.1 | 7.2 | 5.5 |
| (kpsi) | | | | | | | | |
| Hardness (Shore | 39.0 | 43.0 | 49.3 | 48.1 | 47.0 | 45.3 | 49.5 | 46.2 |
| D) | | | | | | | | |
| Taber Loss | 193.3 | 39.8 | 29.7 | 14.3 | 56.7 | 20.1 | 16.5 | 13.2 |
| (mg/1000rev)- 1 kg | | | | | | | | |
| load | | | | | | | | |
| MFI (g/10 min) at | 200.0 | 136.0 | 15.0 | 36.0 | 45.0 | 15.1 | 10.0 | 3.9 |
| 230° C. | | | | | | | | |

The data in Table 1 illustrate that using a modified polyisocyanate provides improved mechanical properties compared to functionalized thermoplastic polyurethane compositions alone. Both tensile properties and flexure properties increase. Specifically, mechanical properties of the modified TPU-1 comprising modified polyisocyanates(s) improve dramatically compared to the neat TPU-1, which is prepared using the equivalent ratio of 0.95. In addition, abrasion resistance improves while the material still has flowability.

These test results show that compositions within the scope of the present invention first can be easily processed as a thermoplastic material, and then be induced to crosslink, to achieve excellent durability. These final properties can be optimized for specific golf ball applications by adjusting the type and ratio of urethane, modified isocyanate, and any additional materials in the composition. Additionally, the degree of crosslinking in the composition can be adjusted by selecting the processing method and conditions used to make the compositions.

### Example 2

This example concerns the production of golf balls using disclosed compositions, and the physical properties of golf balls made using such compositions.

Mantled cores having the construction shown in Table 2 were prepared by compression molding followed by injection molding. Cover materials having a composition as shown in Table 2 were prepared using a twin-screw extruder to make pellet shaped materials. The obtained cover material was formed as a cover layer by injection molding. The processing temperature was from 220 to 260° C. Golf balls made by this process were aged at room temperature for one week. Based on the aforementioned test method, the ball hardness and shear durability were evaluated. The results are shown in Table 2.

TABLE 2

| | Batch | | | | | | | |
|---|---|---|---|---|---|---|---|---|
| | #1 | #2 | #3 | #4 | #5 | #6 | #7 | #8 |
| TPU-1 | 100 | 100 | 100 | 100 | | | | |
| TPU-2 | | | | | 100 | 100 | 100 | 100 |
| Mondur ® CD/Desmodur ® | | 2.5 | 5 | 2.5 | | 2.5 | 5 | 2.5 |
| N3600 = 2/1 | | | | | | | | |
| NW5 | | | | 1 | | | | 1 |
| Core | 1.48″ 70 cc | | | | | | | |
| Mantle | 1.58″ Surlyn blend | | | | | | | |
| Cover | 0.05″ Injection molding | | | | | | | |
| Ball hardness | 46 | 48 | 52 | 51 | 50 | 50 | 51 | 50 |
| Shear durability | 3.04 | 2.29 | 1.82 | 3.42 | 3.42 | 1.92 | 1.08 | 1.64 |

TP Black: 1.17,
Max Fire: 3.83

For golf ball batches #3 to #8, except #7, having TPU modified cover stock, shear durability tests revealed a durability improvement compared to the shear durability for golf balls of batch #1 and #2. Specifically, shear durability improved with an increasing amount of modified polyisocyanate in the composition. Without being limited to a theory of operation, this excellent durability may be caused by a 3-dimensional crosslinked structure in the cover layer due to the reaction between active hydroxyl group or groups and an isocyanate group or groups provided by the modified polyisocyanate.

1. A resin composition comprising (a) a functionalized polymeric material comprising a reaction product of a polyol and/or polyamine, a diisocyanate or polyisocyanate, and a chain extender, and (b) at least one modified polyisocyanate selected from 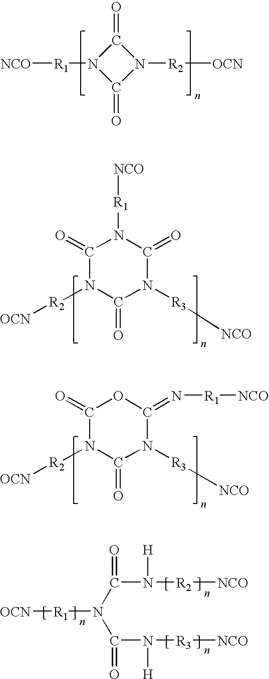
or mixtures thereof, wherein n is 1 or greater, and R₁, R₂, and R₃ independently are aliphatic, substituted aliphatic, cyclic aliphatic, aryl, or heteroaryl groups having from 1 to 20 carbon atoms, or mixtures thereof.

2. The composition according to claim 1, where the modified polyisocyanate has at least three isocyanate functional groups, where the isocyanate functional groups can include blocked isocyanates formed by linkage between two or multiple isocyanates.

3. The resin according to claim 1, where an equivalent ratio between isocyanate groups of the diisocyanate or polyisocyanate and hydroxyl group of the polyol and/or amino group of the polyamine for the functionalized polymeric material is greater than 0.6 and less than 1.03.

4. The composition according to claim 1, where the modified polyisocyanate is formed using a monomeric diisocyanate or triisocyanate selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

5. The composition according to claim 1, wherein the modified polyisocyanate includes a blocked modified polyisocyanate comprising blocking agents selected from ε-caprolactam, butanone oxime, 1,2-pyrazole, 1,2,4-triazole, diisopropylamine, 3,5-dimethylpyrazole, diethyl malonate, and combinations thereof.

6. The composition according to claim 1, wherein the modified polyisocyanate is used in an amount of from about 0.1 to about 20 parts based on the weight of functionalized polymer.

7. The composition according to claim 1, wherein the modified polyisocyanate comprises a mixture of a modified aromatic polyisocyanate and a modified aliphatic polyisocyanate in a weight ratio of from about 0.1:10 to about 10:0.1.

8. The composition according to claim 1, wherein an equivalent ratio between isocyanate functional groups and hydroxyl groups of a diol and/or a polyol and amino groups of the polyamine is greater than 0.65 and less than 1.02.

9. A golf ball, comprising:
a core; and
at least one layer made of a resin composition comprising (a) a functionalized polymeric material comprising a reaction product of a polyol and/or polyamine, a diisocyanate or polyisocyanate, and a chain extender, and (b) at least one modified polyisocyanate selected from 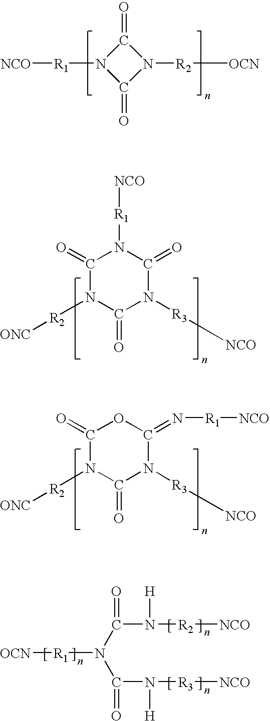
or mixtures thereof, wherein n is 1 or greater, and R₁, R₂, and R₃ independently are aliphatic, substituted aliphatic, cyclic aliphatic, aryl, heteroaryl, having from 1 to 20 carbon atoms, or mixtures thereof.

10. The golf ball of claim 9, where an equivalent ratio between isocyanate groups of the diisocyanate or polyisocyanate and hydroxyl group of the polyol and/or amino group of the polyamine for the functionalized polymeric material is greater than 0.6 and less than 1.03.

11. The golf ball of claim 9, wherein the modified polyisocyanate is formed using a monomeric diisocyanate or triisocyanate selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

12. The golf ball of claim 9, wherein the modified polyisocyanate includes a blocked modified polyisocyanate comprising blocking agents selected from ε-caprolactam, butanone oxime, 1,2-pyrazole, 1,2,4-triazole, diisopropylamine, 3,5-dimethylpyrazole, diethyl malonate, and combinations thereof.

13. The golf ball of claim 9, wherein the modified polyisocyanate is used in an amount of from about 0.1 to about 20 parts based on the weight of functionalized polymer.

14. The golf ball of claim 9 comprising at least one outer core layer and mantle layer, where the at least one outer core layer and mantle layer comprise:
(a) an ionomeric polymer comprising one or more E/X/Y copolymers, wherein E is ethylene, X is a C₃ to C₈ α,β ethylenically unsaturated carboxylic acid, and Y is a softening comonomer selected from alkyl acrylate and alkyl methacrylate, wherein the alkyl groups have from 1 to 8 carbon atoms, or ionomers of such E/X/Y copolymers, wherein X is from about 5 to about 35 weight % of the E/X/Y copolymer and Y is from 0 to about 50 weight % of the E/X/Y copolymer, and wherein the acid groups present in the ionomeric polymer are partially neutralized with a metal selected from zinc, sodium, lithium, calcium, magnesium, and combinations thereof; or
(b) a bimodal ionomeric polymer comprising (i) a high molecular weight component having a molecular weight in the range of from about 80,000 to about 500,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the high molecular weight component is partially neutralized with metal ions selected from lithium, sodium, zinc, calcium, magnesium, and combinations thereof, and (ii) a low molecular weight component having a molecular weight in the range of from about 2,000 to about 30,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the low molecular weight component is partially neutralized with metal ions selected from lithium, sodium, zinc, calcium, magnesium, and combinations thereof; or
(c) a modified ionomeric polymer comprising (i) a blend composition comprising ethylene, from about 5 to about 25 weight percent (meth)acrylic acid (based on the total weight of the modified ionomeric polymer), and from 0 to about 40 weight percent of a C₁ to C₈ alkyl acrylate (based on the total weight of the modified ionomeric polymer), and from about 5 to about 45 weight percent (based on the total weight of the modified ionomeric polymer) of a fatty acid or one or more metal salts of a fatty acid, or (ii) a bimodal polymer blend composition comprising a high molecular weight component having a molecular weight in the range of from about 80,000 to about 500,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the high molecular weight component is partially neutralized with metal ions selected from lithium, sodium, zinc, calcium, magnesium, and combinations thereof, and a low molecular weight component having a molecular weight in the range of from about 2,000 to about 30,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the low molecular weight component is partially neutralized with metal ions selected from lithium, sodium, zinc, calcium, magnesium, and combinations thereof, and from about 5 to about 45 weight percent (based on the total weight of the modified ionomeric polymer) of a fatty acid or one or more metal salts of a fatty acid; or
(d) a blend composition comprising the reaction product of (i) one or more ionomers, and (ii) a compound having a general formula (R₂N)ₘ—R′—(X(O)ₙOR_{y})ₘ, where R is selected from hydrogen, one or more C₁-C₂₀ aliphatic systems, one or more cycloaliphatic systems, one or more aromatic systems, and combinations thereof, where R′ is a bridging group comprising one or more unsubstituted C₁-C₂₀ straight chain or branched aliphatic or alicyclic groups, or one or more substituted straight chain or branched aliphatic or alicyclic groups, or one or more aromatic groups, or one or more oligomers each containing up to 12 repeating units, wherein when X=C or S or P, m is 1-3, when X=C, n=1 and y=1, when X=S, n=2 and y=1, and when X=P, n=2 and y=2; or
(e) combinations of (a), (b), (c), and (d).

15. The golf ball of claim 9 comprising at least one outer core layer and mantle layer, where the at least one outer core layer and mantle layer comprise an injection moldable polyalkenamer rubber composition, the injection moldable polyalkenamer rubber composition further comprising (i) at least one cross-linking agent selected from sulfur compounds, peroxides, azides, maleimides e-beam radiation, gamma-radiation, and all combinations thereof; or (ii) at least one co-cross-linking agent comprising a zinc or magnesium salt of an unsaturated fatty acid having from 3 to 8 carbon atoms, or (iii) at least one peptizer; or (iv) at least one accelerator; or (v) at least one filler; or (vi) any and all combinations of i, ii, iii, iv, and v.

16. The golf ball of claim 9 comprising at least one intermediate layer and a cover comprising the resin composition.

17. The golf ball of claim 9, having a cover with a thickness of from about 0.01 to about 0.1 inch.

18. The golf ball of claim 9, having an outer core layer with a thickness of from about 0.01 to about 1.14 inch.

19. The golf ball of claim 9, having an intermediate layer with a thickness of from about 0.01 to about 0.1 inch.

20. The golf ball of claim 9, wherein the golf ball has a coefficient of restitution (COR) greater than 0.700 at 125 ft/sec or 143 ft/sec inbound velocity.

21. The golf ball of claim 9, having a core with a diameter of from 0.1 inch to 1.65 inches.

22. The golf ball of claim 9, having a PGA ball compression from about 30 to at least 60.

23. The golf ball of claim 9, having a core compression of from 80 to 140.

24. The golf ball of claim 9, where:
(a) core material has a flexural modulus (F1)<30 kpsi;
(b) the golf ball has an outer core or inner mantle, and outer core material or inner mantle material has a flexural modulus (F2) of from about 5 to about 60 kpsi;
(c) the golf ball has an outer mantle, and outer mantle material has a flexural modulus (F3) of from about 30 to about 130 kpsi;
and wherein, with reference to these moduli,
(d) F1<F2<F3; F1<F2 at least by 3, preferably by 5, more preferably by 10 kpsi; and F2<F3 at least by 3, preferably by 5, more preferably by 10 kpsi

25. The golf ball of claim 9, where:
(a) core compression (C1) is from about 10 to about 100,
(b) core compression and outer core compression (C2) is from about 40 to about 90,
(c) the core compression, the outer core compression or inner mantle compression, and outer mantle compression (C3) is from about 60 to about 120,
(d) ball compression (C4) is from about 70 to about 130, and wherein
(e) C1<C2<C3; C1<C2 at least by 5, more preferably by 10, and most preferably by 15 compression units; C2<C3 at least by 5, more preferably by 10 and most preferably by 15 compression units; and C3-C4<10 compression units.

26. The golf ball of claim 24, where the inner mantle layer has a thickness of less than 0.15 inches and a Shore D hardness of from about 20 to about 70.

27. The golf ball of claim 24, where the outer mantle layer has a thickness of from about 0.010 to about 0.15 inches and a Shore D hardness of from about 30 to about 90.

28. The golf ball of claim 24, at least one outer core layer and mantle layer comprises:
(a) an ionomeric polymer comprising one or more E/X/Y copolymers, wherein E is ethylene, X is a C₃ to C₈ α,β-ethylenically unsaturated carboxylic acid, and Y is a softening comonomer selected from alkyl acrylate and alkyl methacrylate, wherein the alkyl groups have from 1 to 8 carbon atoms, or ionomers of such E/X/Y copolymers, wherein X is from about 5 to about 35 weight % of the E/X/Y copolymer and Y is from 0 to about 50 weight % of the E/X/Y copolymer, and wherein acid groups present in the ionomeric polymer are partially neutralized with a metal selected from zinc, sodium, lithium, calcium, magnesium, and combinations thereof; or
(b) a bimodal ionomeric polymer comprising (i) a high molecular weight component having a molecular weight of from about 80,000 to about 500,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the high molecular weight component is partially neutralized with metal ions selected from lithium, sodium, zinc, calcium, magnesium, and combinations thereof, and (ii) a low molecular weight component having a molecular weight of from about 2,000 to about 30,000 and comprising one or more ethylene/α,β-ethylenically unsaturated C₃-C₈ carboxylic acid copolymers and/or one or more ethylene, alkyl (meth)acrylate, (meth)acrylic acid terpolymers, wherein the low molecular weight component is partially neutralized with metal ions selected from lithium, sodium, zinc, calcium, magnesium, and combinations thereof; or
(c) a modified ionomeric polymer comprising (i) a blend composition comprising ethylene, from about 5 to about 25 weight percent (meth)acrylic acid (based on total weight of the modified ionomeric polymer), and from 0 to about 40 weight percent of a C₁ to C₈-alkyl acrylate (based on total weight of the modified ionomeric polymer), and from about 5 to about 45 weight percent (based on total weight of modified ionomeric polymer) of a fatty acid or one or more metal salts of a fatty acid, or (ii) a bimodal polymer blend composition comprising a high molecular weight component having a molecular weight of from about 80,000 to about 500,000 and comprising one or more ethylene/α,β-ethylenically unsaturated C₃₋₈ carboxylic acid copolymers and/or one or more ethylene, alkyl(meth)acrylate, (meth)acrylic acid terpolymers, wherein the high molecular weight component is partially neutralized with metal ions selected from lithium, sodium, zinc, calcium, magnesium, and combinations thereof, and a low molecular weight component having a molecular of from about 2,000 to about 30,000 and comprising one or more ethylene/α,β-ethylenically unsaturated C₃-C₈ carboxylic acid copolymers and/or one or more ethylene, alkyl(meth)acrylate, (meth)acrylic acid terpolymers, wherein the low molecular weight component is partially neutralized with metal ions selected from lithium, sodium, zinc, calcium, magnesium, and combinations thereof, and from about 5 to about 45 weight percent (based on the total weight of the modified ionomeric polymer) of a fatty acid or one or more metal salts of a fatty acid; or
(d) a blend composition comprising the reaction product of (i) one or more ionomers, and (ii) a compound having a general formula (R₂N)ₘ—R′—(X(O)ₙOR_{y})ₘ, wherein R is selected from hydrogen, one or more C₁-C₂₀ aliphatic systems, one or more cycloaliphatic systems, one or more aromatic systems, and combinations thereof, where R′ is a bridging group comprising one or more unsubstituted C₁-C₂₀ straight chain or branched aliphatic or alicyclic groups, or one or more substituted straight chain or branched aliphatic or alicyclic groups, or one or more aromatic groups, or one or more oligomers each containing up to 12 repeating units, and wherein when X═C or S or P, m is 1-3, when X=C, n=1 and y=1, when X=S, n=2 and y=1, and wherein when X=P, n=2 and y=2; or
(e) combinations of (a), (b), (c), and (d).

29. The golf ball of claim 24, where at least one outer core layer and mantle layer comprises an injection moldable polyalkenamer rubber composition, the injection moldable polyalkenamer rubber composition further comprising (i) at least one cross-linking agent selected from sulfur compounds, peroxides, azides, maleimides e-beam radiation, gamma radiation, and all combinations thereof; or (ii) at least one co-cross-linking agent comprising a zinc or magnesium salts of an unsaturated fatty acid having from 3 to 8 carbon atoms; or (iii) at least one peptizer; or (iv) at least one accelerator; or (v) at least one filler; or (vi) any and all combinations of i, ii, iii, iv, and v.

30. The golf ball of claim 9, where:
(a) core material has a flexural modulus (F1)<30 kpsi;
(b) the golf ball has an outer core or inner mantle, and outer core material flexural modulus or inner mantle material flexural modulus (F2) is from about 25 to about 130 kpsi;
(c) the golf ball has an outer mantle, and outer mantle material flexural modulus (F3) is from about 5 to about 60 kpsi; and
(d) F2≧F3.

31. The golf ball of claim 30, where:
(a) core compression (C1) is from about 10 to about 100;
(b) core compression and inner mantle compression (C2) is from about 60 to about 120;
(c) core compression, outer core compression or inner mantle compression, and outer mantle compression (C3) is from about 60 to about 120;
(d) ball compression (C4) is from about 70 to about 130; and
(e) C1<C2≧C3-5, preferably C1<C2≧C3-10, C1<C2 at least by 5, more preferably by 10, and most preferably by 15 compression units, and C3-C4<5 compression units.

32. The golf ball of claim 30, where the inner mantle layer has a thickness of from about 0.010 to about 0.10 inch and a Shore D hardness of from about 20 to about 90.

33. A method for making sports equipment with a resin comprising a reaction product of (a) a functionalized polymeric material comprising at least one hydroxyl functional group, at least one amine functional group or at least one hydroxyl functional group and at least one amine functional group, and (b) at least one modified polyisocyanate selected from 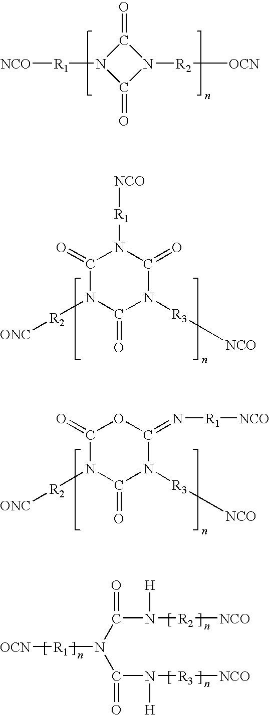
or mixtures thereof, wherein n is about 1 or greater, and R₁, R₂, and R₃ independently are aliphatic, substituted aliphatic, cyclic aliphatic, aryl, heteroaryl, or mixtures thereof; and
making sports equipment comprising the composition.

34. The method according to claim 33 where the equipment is a golf ball, and the method comprises:
(1) forming the composition into half cups, and positioning the half cups about the core or intermediate layer to form a layer, or
(2) injection molding the composition to form a layer on the core or intermediate layer.

35. The method according to claim 33 where the method further includes forming a three- to five-piece ball, wherein at least one golf ball layer comprises the resin composition, with or without post cure.
